(19) United States
(12) Patent Application Publication
(10) Pub. No.: US 2005/0168973 A1
(43) Pub. Date: Aug. 4, 2005

(54) Artificial miniature, landscape model with three dimensionally variable colored LEDS

(76) Inventor: Hsien-Tsung Chuang, Bail Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/770,500

(22) Filed: Feb. 4, 2004

(51) Int. Cl. F21S 6/00; F21V 33/00

(52) U.S. Cl. 362/122; 362/806; 362/234

(57) ABSTRACT

An artificial miniature landscape model comprises a plurality of automatically color variable LEDS (or called multi-colored LEDS), metallic conductor branches, electrical insulation conductors, heat shrink bushings, or insulation tubular plugs, or internally or externally threaded tubular connectors, a low voltage rectifier, base connectors, flowers, leaf blades, birds, fruits, butterflies, molded coniferous Christmas tree, and pots wherein a plurality of variable colored LEDS are affixed to a molded transparent resin structure of artificial flower, fruit, bird, leaf or butterfly so as to exhibit a three dimensionally colored lighting effect of LEDS. Bedsides, several newly developed manipulative means for connection of electrical conductors for supplying power to illuminate the LEDS and to operate the electricall device accompanied with the miniature landscape model are also provided.

### BACKGROUND OF THE INVENTION

1. Field of the Invention

The present invention relates to artificial miniature landscape model which are ornamented with three dimensionally variable colored LEDS.

2. Description of the Prior Art

The conventional illuminated decorative potted plats which can be bought from the markets are usually formed of a fixture containing an incandescent lamp. As it is well known that the incandescent lamp has several inherent disadvantages of a low efficiency, a short lifetime and a low light intensity therefore it is not suitable for use where the ample color variation and light intensity are required.

Besides, in stead of the incandescent lamp, LEDS are installed in the bottom cavity of a rotatable pot to illuminate the potted plant upwardly from the bottom, however, the bottom of the pot often interrupt transmission of the light beam of the LEDS to illuminate the plat thereby considerably lowering the lighting effect.

In view of this, a light source is introduced to the flower with an optical fiber conductor, but as the light source is a spot light affixed to the flower without matching with the contour of the flower so that there will be in lack of a three dimensionally vivid appealing, and for demonstration of an active feeling, the pot is rotated by a driving motor together with a color disc thereby always causing inevitable noise from the rotating motor and shortening the durability of the light source.

### SUMMARY OF THE INVENTION

Aiming at the above depicted defects inherent to the prior techniques, the present invention is to propose a newly developed construction of an artificial miniature landscape model with three dimensionally variable colored LEDS (or called multi-colored LEDS), wherein variable colored LEDS are affixed to a molded transparent resin structure of artificial flower, fruit, bird, leaf, and butterfly so as to exhibit a three dimensionally variable colored lighting effect of the LEDS contained in the transparent molded resin structure.

The main structure of the first embodiment comprises an artificial miniature landscape model with three dimensionally colored LEDS is essentially composed of a plurality of automatic color variable LEDS, metallic conductor submains, heat shrink bushings or heat resisting insulation tube plugs, externally or internally threaded tube connectors, electrical insulation conductors, a low voltage rectifier, flowers, leaf blades, fruits, birds, butterflies, coniferous Christmas trees formed into molded transparent resin structures, and pots.

Wherein it is characterized in that said LEDS are sealed in said molded transparent resin structure with a certain properly inclined angle, said submains of the potted plant are constructed of a plurality of various sized (diameters) copper tubes bent and welded, and being assembled section by section with screw engaging;

The root of a trunk of said potted plant is provided with two flanges and is fixed into said pot with a binder made of mixed resin and ballasts, the electricity is supply from a low voltage rectifier via a power supply switch to said LEDS.

The above object and other advantages of the present invention will become more apparent by describing in detail the preferred embodiments of the present invention with reference to the following attached drawings.

### BRIEF DESCRIPTION OF THE DRAWINGS

FIG. 1 is an assembly view of a potted plant with flowers and a butterfly resting on a flower corolla

FIG. 2 is an assembly view of a potted plant with flowers, fruits and birds perching on a tree branch;

FIG. 3 is a schematic view of a potted Christmas tree;

FIG. 4 is a schematic view showing the assembled structure of pot, with solid copper conductors with flanges;

FIG. 5 a schematic view of a LED affixed to a leaf;

FIG. 6 is a schematic view showing a group of LEDS are affixed to a flower and a leaf;

FIG. 7 is a schematic view showing how a butterfly together with LEDS is supported;

FIG. 8 is a schematic view showing a bird with LEDS perches on a tree branch;

FIG. 9 is a schematic view sowing a fruit affixed with LEDS;

FIG. 10 is a schematic view showing a coniferous leaf of a Christmas tree affixed with a LED;

FIG. 11 is a schematic view of a potted plant of African daisy (sunflower) with LEDS;

FIG. 12 is a schematic view of a potted plant of tulip with LEDS;

FIG. 13 is a schematic view of a potted plant of orchid with LEDS;

FIG. 14 is a schematic view showing an artificial orchid with LEDS;

FIG. 15 is a schematic view showing a group of LEDS and an A connector;

FIG. 16 is a schematic view showing a group of LEDS and a B connector;

FIG. 17 is a schematic view showing a potted plant of calla lily flowers connected with A connectors;

FIG. 18 is a schematic view showing a potted plant of hyacinth flowers connected with B connectors;

FIG. 19 is a schematic view showing a potted plant of rose flowers connected with both A and B connectors

FIG. 20 is an exploded view of a medium or large sized potted plant;

FIG. 21 is an assembly view of medium or large sized potted plant;

FIG. 22 is a schematic view showing an electrical circuit layout in the rear of a pot;

FIGS. 23 and 23A are schematic views showing how the flowers of a medium or small sized potted plant are assembled;

FIG. 24 is an assembly view of a medium or small sized potted plant (1);

FIG. 25 is an assembly view of a medium or small sized potted plant (2)

FIG. 26 is a schematic view showing a spruce and LEDS annected with optical fibers;

FIG. 26A is a schematic view showing two spades flowers are connected with optical fibers;

FIG. 27 is a schematic view of a potted plant equipped with a water spray damper and a water circulating system;

FIG. 28 is an idol of a fishing raccoon illuminated with LEDS;

FIG. 29 is an illustrative view showing the way of inserting a heat resisting insulation plug into a copper tubular submain;

FIG. 30 is an illustrative view showing the way of fitting a solid copper branch into an internally threaded copper alloy connector;

FIG. 31 is a schematic vie of an artificial orchid being plugged in an A connector;

FIG. 32 is a schematic view of an artificial coniferous Christmas tree being fitted into a copper tubular branch with a heat resisting insulation plug;

FIG. 33 is a schematic view of an internally threaded copper alloy connector;

FIG. 34 is a schematic view of an externally threaded copper alloy connector;

FIG. 35 is a schematic view showing the way of fixing LEDS to a PCB in the body of artificial butterfly;

FIG. 36 is a schematic view showing the way of connecting LEDS to an A connector in the body of a bird idol;

FIG. 37 is a detailed view illustrating how the LEDS are connected to a B connector in the body of a bird idol;

FIG. 38 is a miniature model landscape wherein a raccoon idol is resting under the maple tree;

FIG. 39 is a schematic view showing several metallic conductor branches are connected to one main conductor tube;

FIG. 40 is a schematic view in which several forms of connecting LEDS to a slim copper alloy tube, are shown;

FIG. 41 is a schematic view of a potted LED illuminated African daisy (sunflower) being assembled with A connectors;

FIG. 42 is a schematic view of a potted LED illuminated tulip being assembled with A connectors;

FIG. 43 is a schematic view of a medium sized potted calla lily with LED and a soft EPC sealed in the molded transparent resin structures formed along the rear surface of the flower and the leaf;

FIG. 44 is a schematic view showing a funnel shaped molded transparent resin structure is formed at the torus of the daffodil for sealing LEDS in there;

FIG. 45 is schematic view showing a funnel shaped molded transparent resin structure is formed at the torus of an Anthurium scherzerianum and having an aperture at the bottom of the leaf stalk;

FIG. 45A is a schematic view showing a funnel shaped molded transparent resin structure is formed at the bottom of a maple leaf stalk;

FIG. 46 is a schematic view showing a cone shaped molded transparent resin structure is formed at the torus of a orchid;

FIG. 47 is a schematic view showing a funnel shaped molded transparent resin structure is formed at the leaf stalk of a cala lily;

FIG. 48A is a schematic view showing various types of electrical connectors employed by the present invention;

FIG. 48B is another schematic view showing various types of electrical connectors employed by the present invention;

FIG. 49 is a front schematic view showing a U or V shaped aperture formed at the stalk of a heptagonal leaf;

FIG. 50 is a rear view of FIG. 49;

FIG. 51A is a schematic assembly view showing a multi-colored light element composed of a plurality of R.G.B original color light emission dies and its control IC are implanted on a PCB and then connected to an A type connector according to the present invention;

FIG. 51B is a schematic assembly view showing a multi-color light element composed of a plurality of R.G.B original color light emission dies and its control IC are implanted on a PCB and then connected to a B type connector according to the present invention; and

FIG. 52 is a schematic assembly view showing a multi-color light element composed of a plurality of R.G.B original color light emission dies and its control IC are implanted on a PCB and then connected to a threaded tubular connector according to the present invention.

### DETAILED DESCRIPTION OF THE PREFERRED EMBODIMENT

Several embodiments of the present invention will be desribed in detail with reference to the attached drawings hereinbelow;

Embodiment 1:

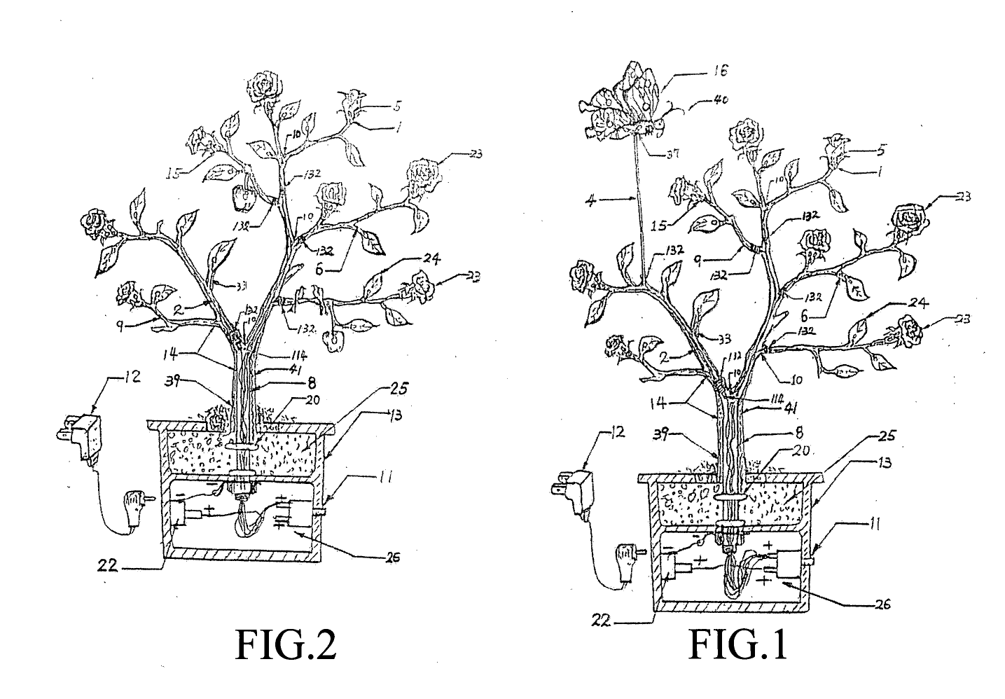

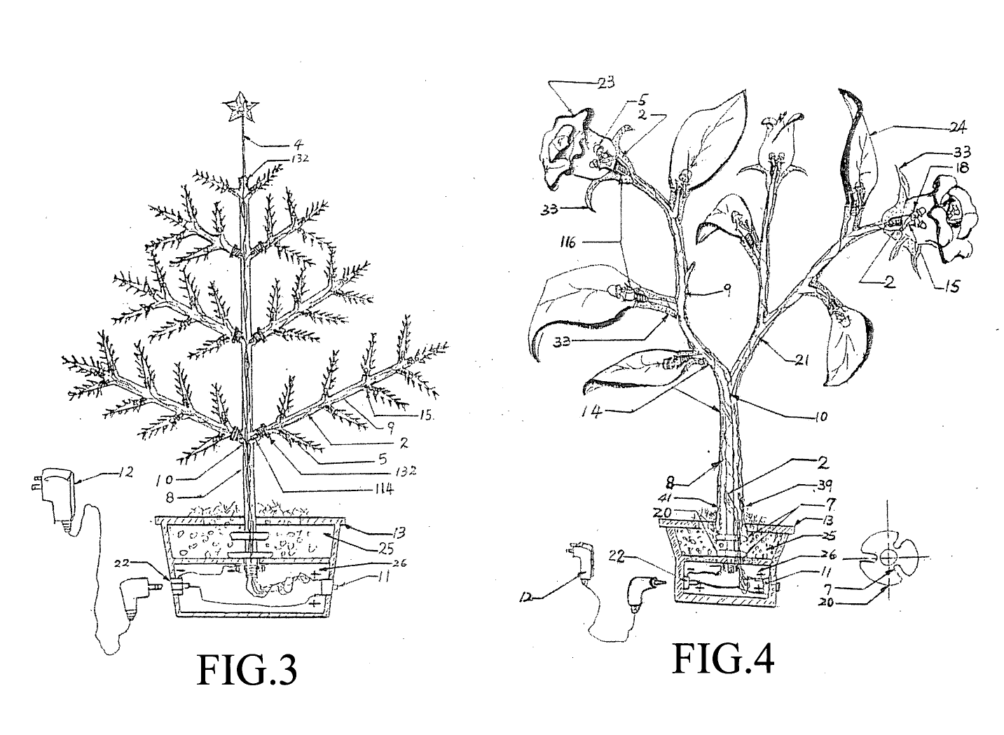

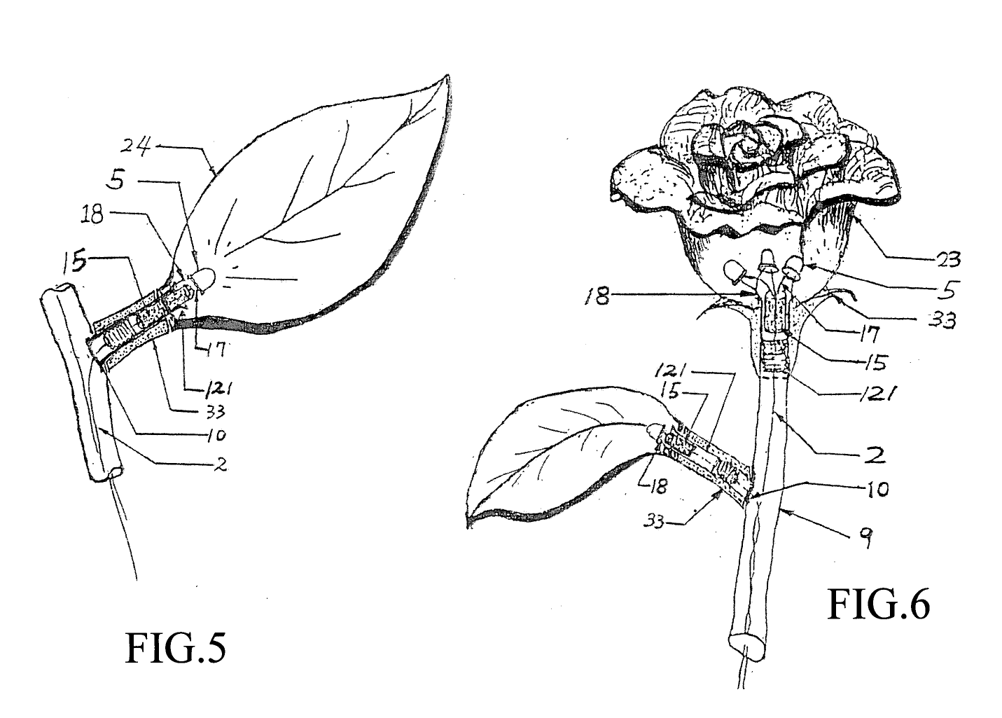

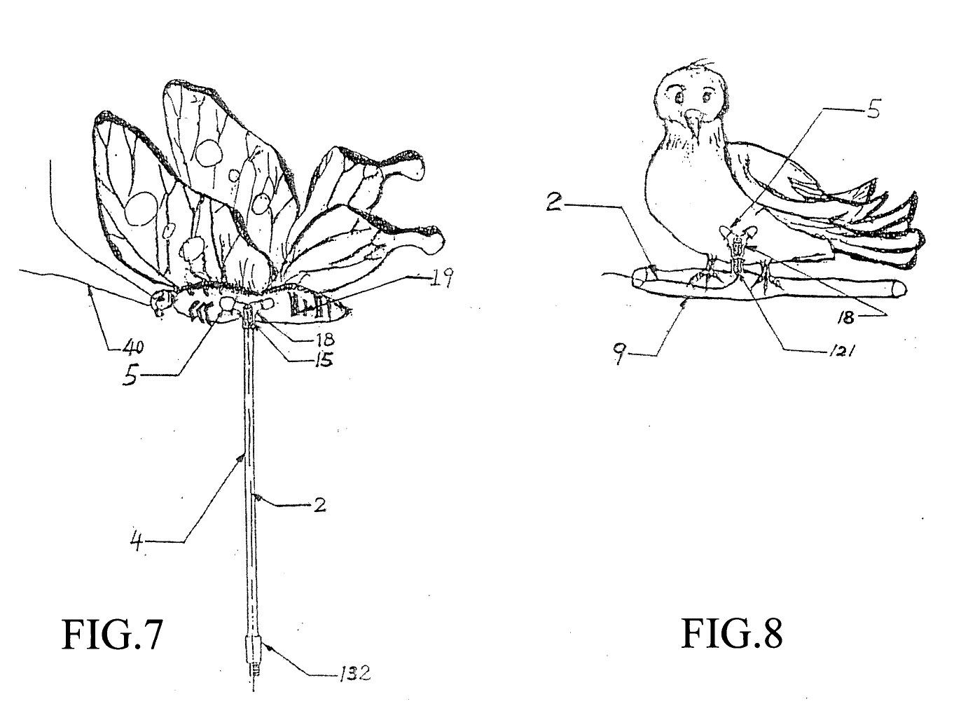

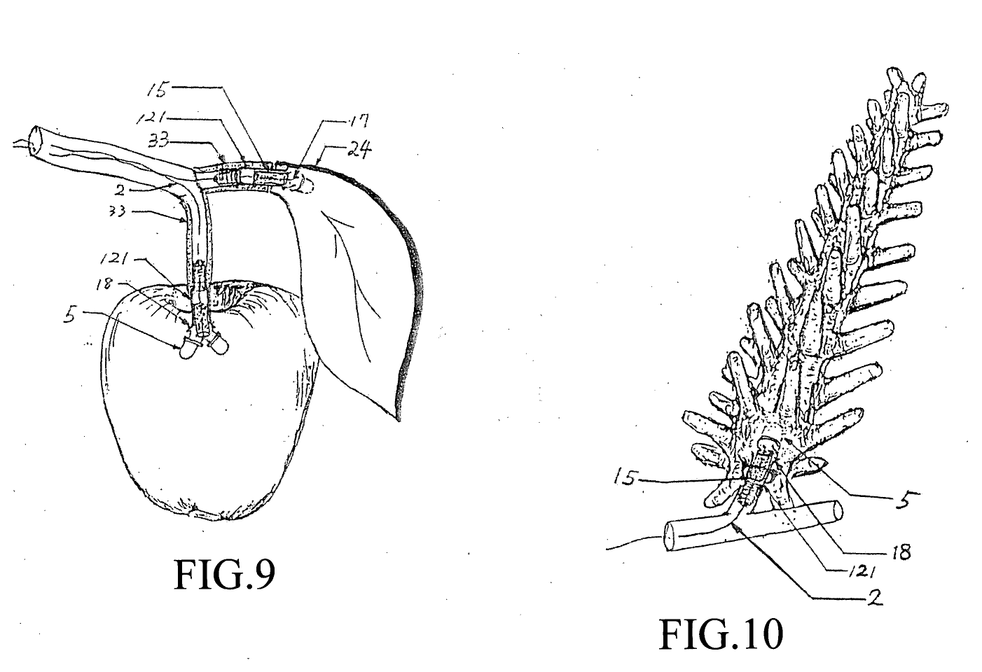

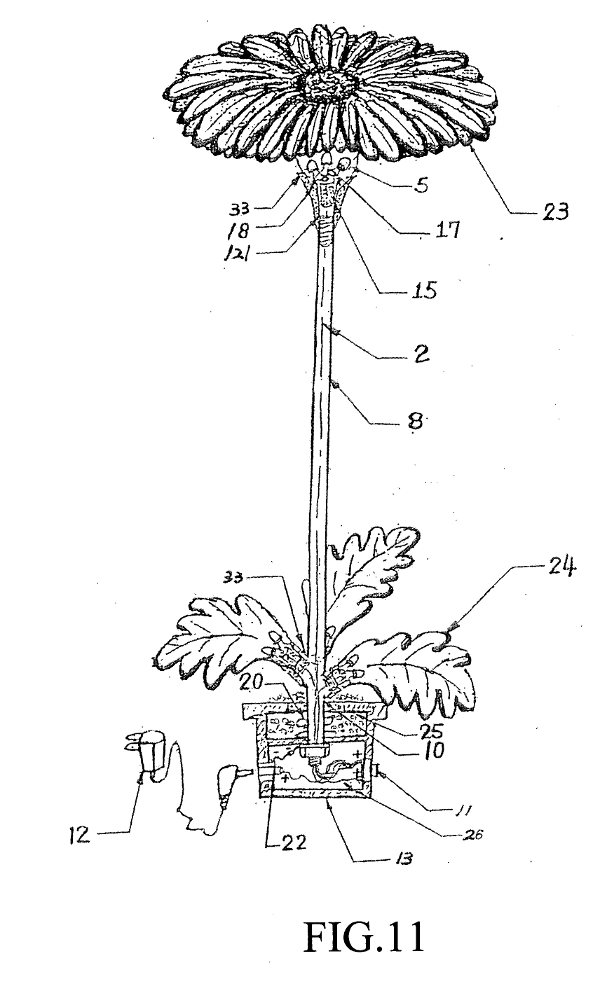

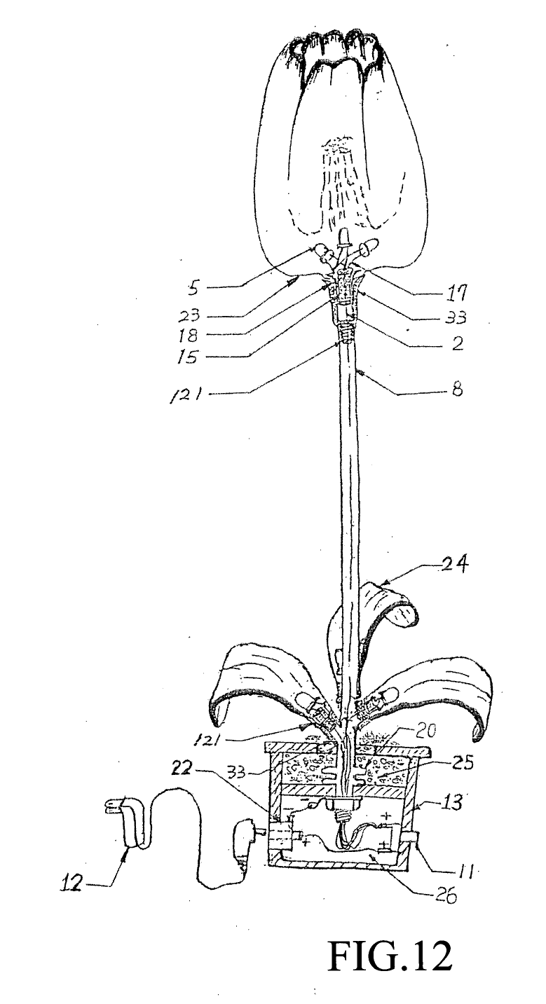

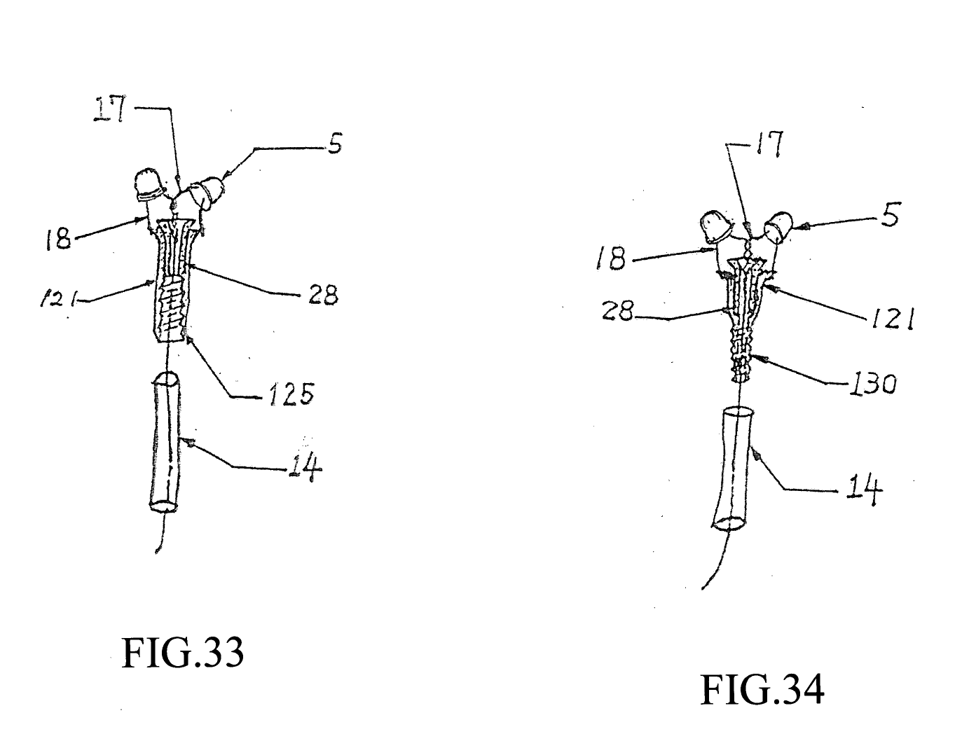

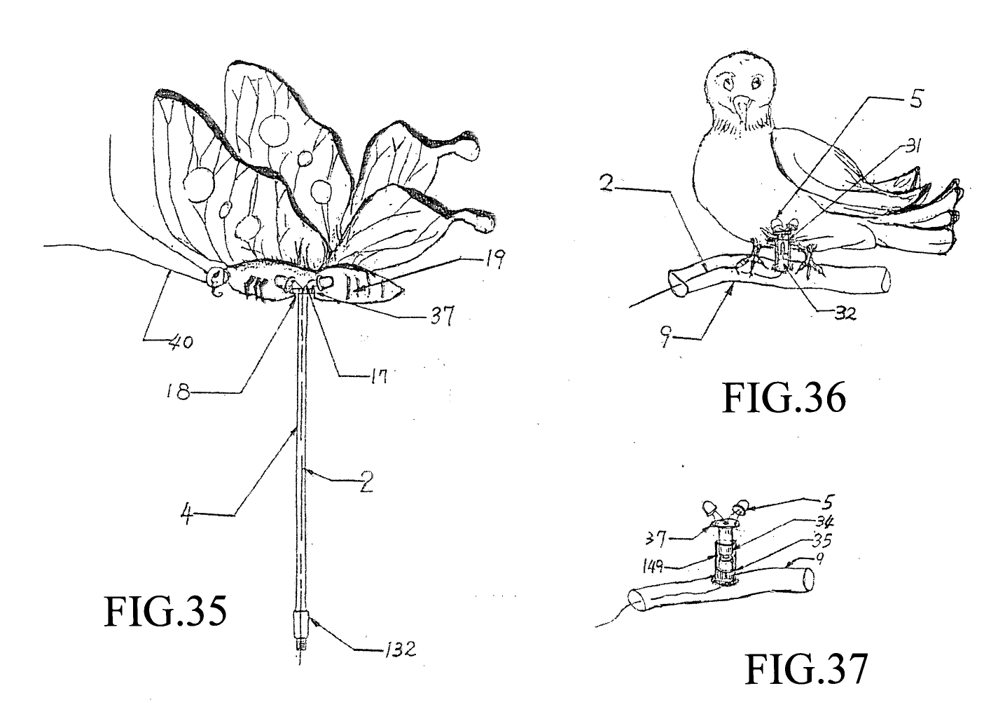

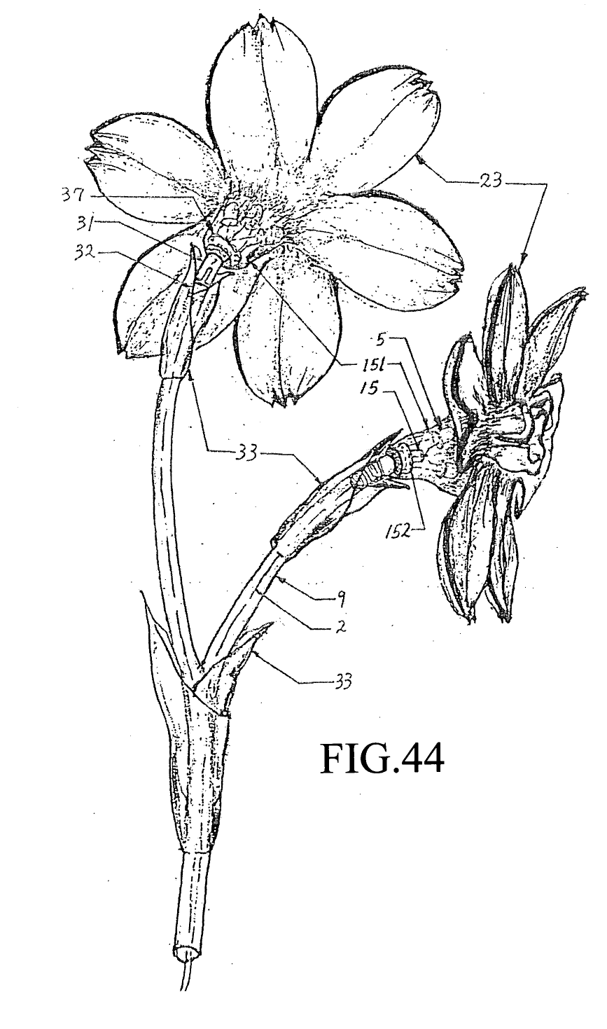

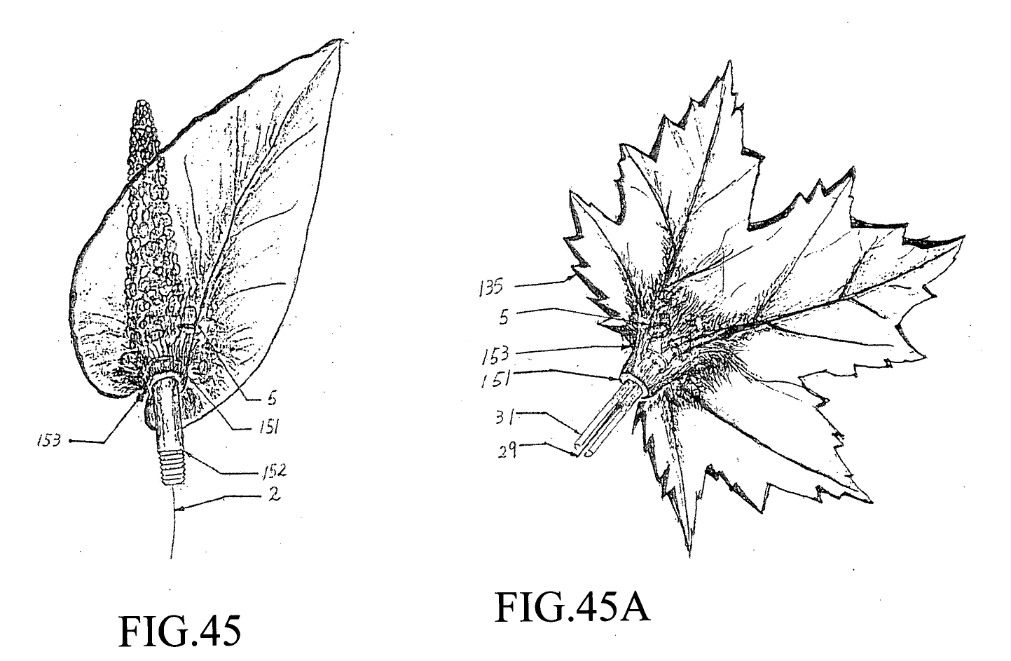

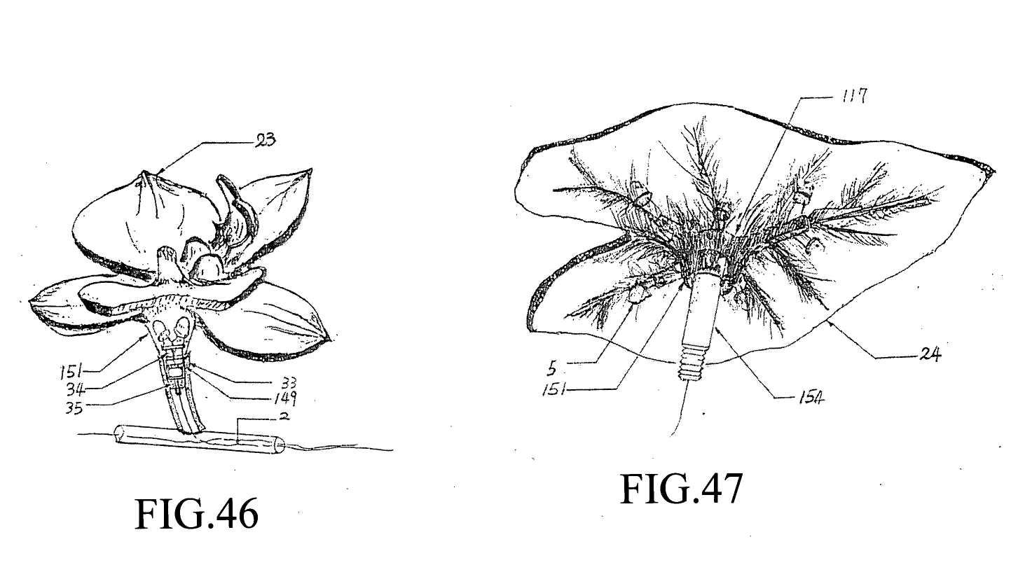

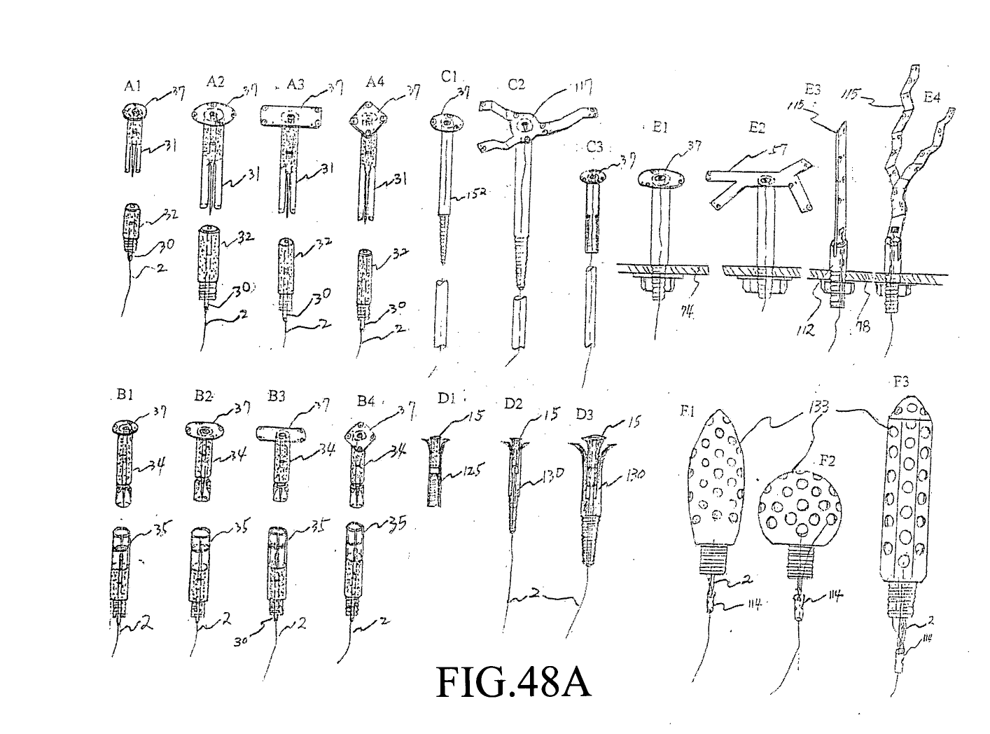

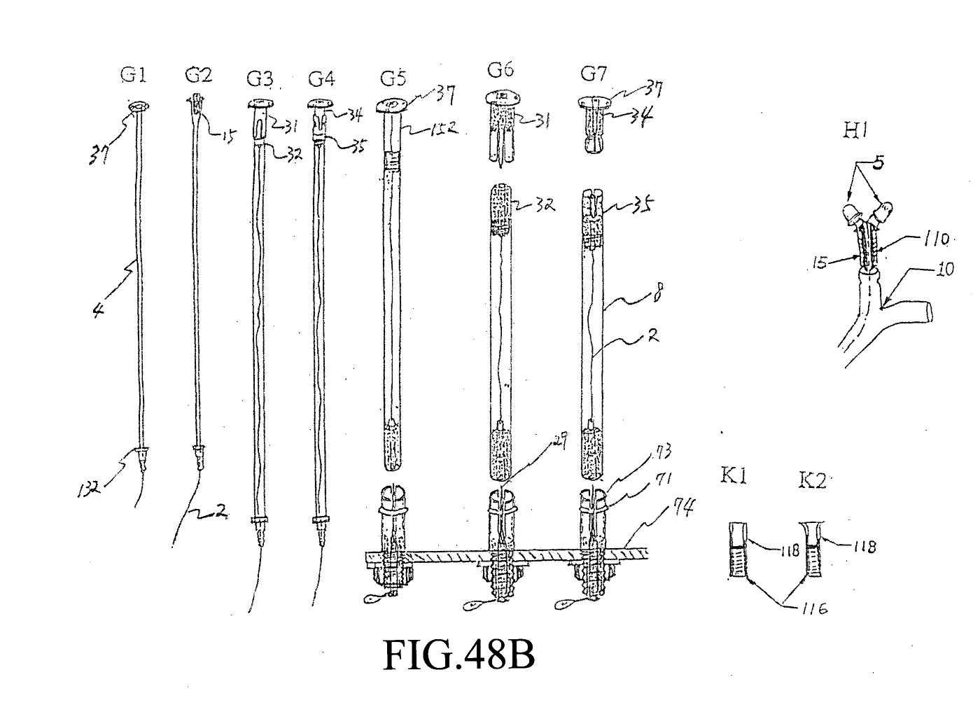

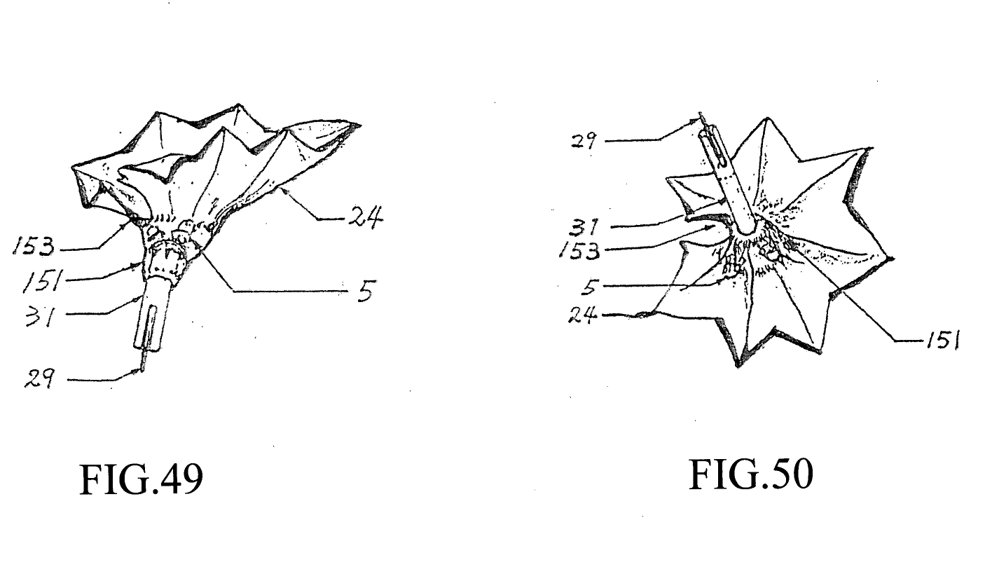

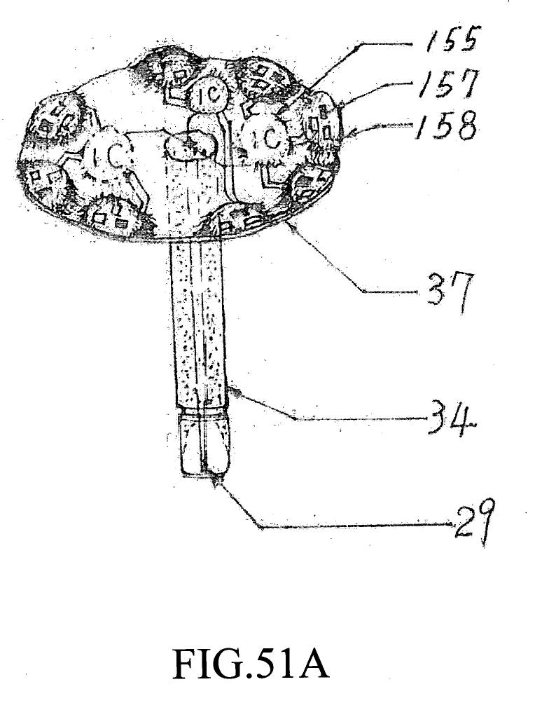

Referring to FIGS. 1,2,3,11,12,13,14,32, The main structure of the first embodiment comprises a plurality of automatically color variable LEDS 5 (or called multi-colored LEDS), metallic conductor branches 14, electrical insulation conductors 2, heat shrink bushings, or insulation tubular plugs, or internally or externally threaded tubular connectors 15 (see FIGS. 33,34), a low voltage rectifier 12, base connectors 22, flowers 23, leaf blades 24, birds, fruits, butterflies, molded coniferous Christmas tree (FIG. 10), and pots 13. The LED 5 is color variable. A plurality of LEDS 5 are sealed in a molded transparent resin structure formed between a leaf stalk 6 and a leaf blade, on a torus 1 beneath the center of the flower, or in the chest of a butterfly 19. In case the flower has no torus (such as orchid, daffodil, see FIGS. 44,76), or the leal blade with a narrow elangated leaf stalk (see FIG. 47). or the flower with a slim torus, a cone shaped or a funnel shaped molded transparent resin structure 151 may be formed beneath the rear of the leaf blade so as to accommodated the LEDS 5 and a PCB. For other types of leaf blade such as colla lily, the plants with heptagonal leaves (see FIGS. 49.50), anthurium sherzerianum (see FIG. 45), and maple leaf (FIG. 45A), a cone or a funnel shaped molded transparent resin structure is formed at the bottom of the leaf stalk and provided with an aperture in correspondence with a U or V aperture 153 along the leaf blade of a real plant. The leaf blade 24 (see FIG. 5), the flower 23 (see FIG. 6), the butterfly (see FIG. 7), the bird (see FIG. 8), the fruit (see FIG. 9), and the conferous Christmas tree (see FIG. 10) are all can be formed into a moled resin structure to exhibit a colorful LED lighting variation on their surface. In order to enhance degree of color and line of silhouette, the molded transparent resin structure can be entirely or partially sand sprayed to form a foggy surface, or partially color painted, or partially semi-transparently color sprayed so as to create an effect of layering color variation. Incidentally, the artificial butterfly feelers may employ optical fibers 40 affixed to its head.

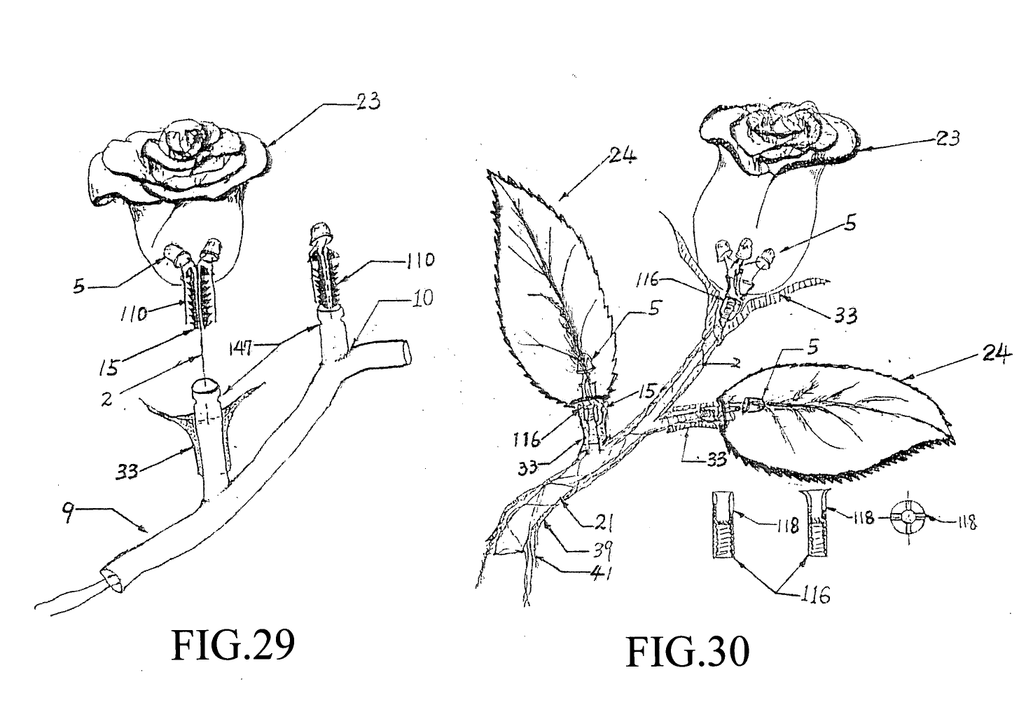

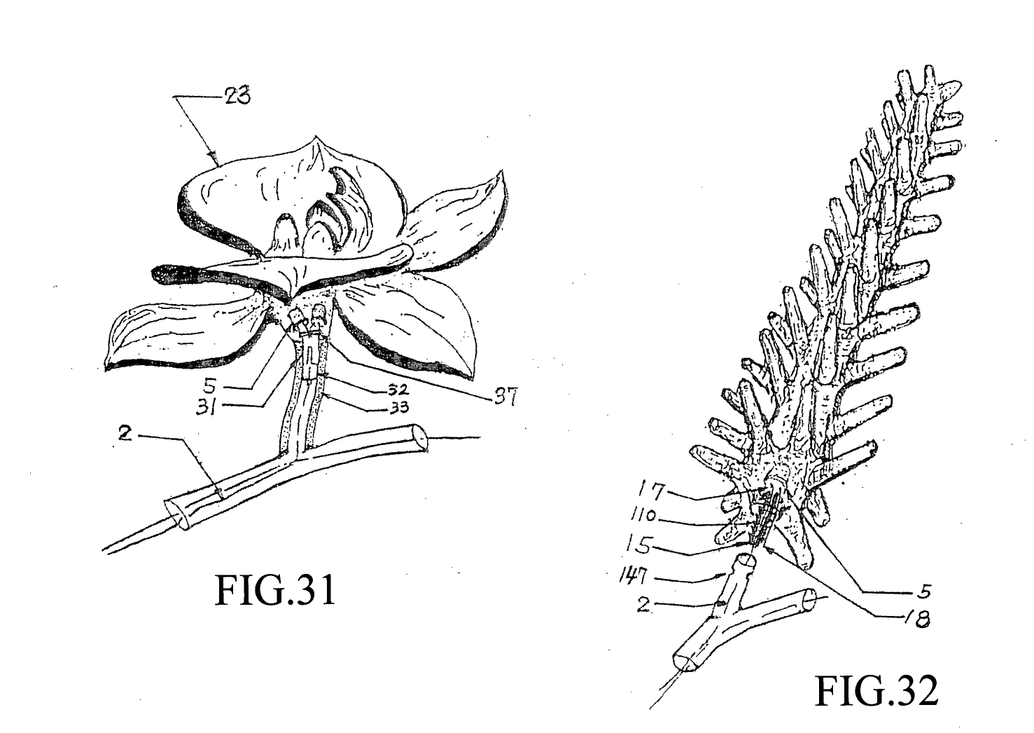

The plant trunk 8 and branch 9 of various flowers 23, leaf blades 24 fruits, butterflies, birds and Christmas trees formed of molded transparent resin structures are formed of metallic tubular submain 14 which being a bunch of a plurality of flexible and various sized metallic copper conductor tubes, copper alloy tubes, or metal plated (silver or tin) tubes 10 welded together. They can be flexed into a desired angle and coated with various colored resin painting, a color resin painting or a resin and stone power mixture 39 and then wrapped with a cotton tape to increase its diameter. The positive terminal pins 17 of the LED which being parallelly welded with a slim electrical insulation conductor is inserted into a heat shrink insulation bushing 15, after it has shrung by heating, it is inserted into the metallic tubular submain 14 and fixed at there. All slim electrical insulation conductors are gathered at the lower chamber 26 of the pot via the metallic tubular submain 14 and weled to one terminal of the power supply switch, while the other terminal thereof is connected to the positive terminal of the base connector 22. the negative terminal pins 18 of the LEDS 5 are welded to the wall surface of the metallic tubular submain 14 so that the submian 14 becomes a negative side conductor. Alternatively the positive terminal, Pins 17 of the LEDS 5 are stranded together and welded to a positive electric conductor and passed through the middle pathway of the insulated tubular plug(see FIG. 29), while the negative terminal pins 18 of the LEDS 5 are respectively welded to the outer wall of the metallic tubular submain 14, or fixed to the outer wall of the insulation tubular plug and then plugged into the tubular submain 14, and a check ring 110 is provided to the plug, or forming two indentations 147 (see FIG. 29) by slightly punching the end of the tubular submain 14, or applying an externally or internally threaded set screw at the end of the submain 14(see FIGS. 33,34) so as to prevent the plug from slipping out. One end of the conductor is welded to a welding terminal provided at the other end of the submain 14; while the other end of the conductor is welded to the negative terminal of the base connector 22. Using the internally and externally threaded set screw, or check ring to retain the tubular plug makes the structure of the present embodiment easy to construct with low cost.

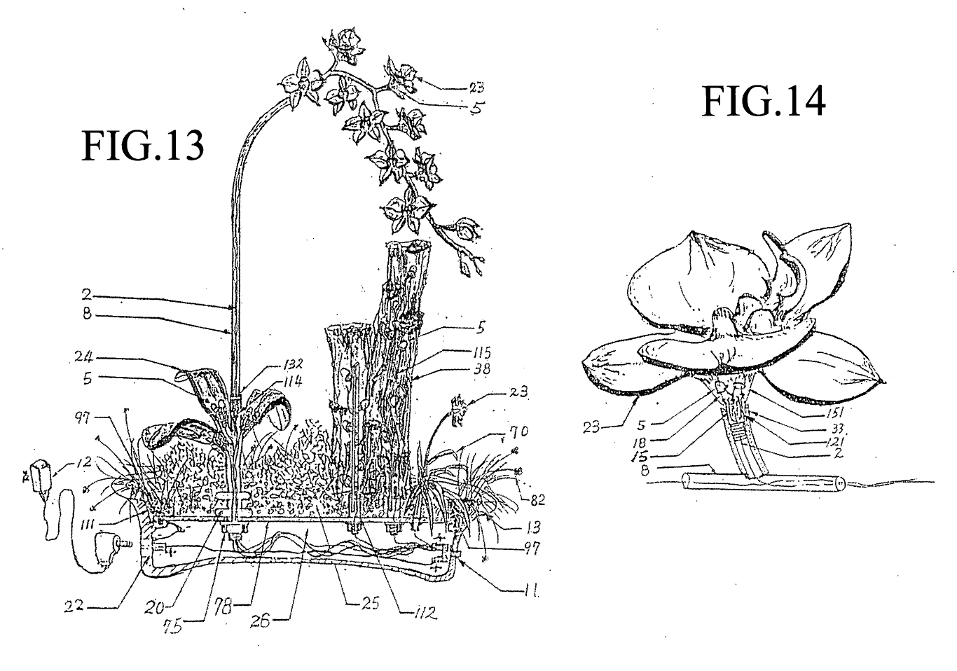

As shown in FIGS. 1,2,3 and 19, the branch 9 and the trunk 8 may be assembled section by section using male and female combination of copper alloy joints 132, and then filling the clearance with soft silicon rubber and coating with color resin painting. The trunk 8 having two flanges 20 at its bottom portion, is set at the upper chamber 25 with the mixture of the resin and ballasts. The power is supplied to the LEDS 5 from a power supply switch 11 through a low voltage rectifier 12. With this arrangement, as shown in FIGS. 13 and 14 a novel, delicate and exquisite decorative artificial potted plats with three dimensionally variable colored LEDS5 can be created in which the leaf blade 24, the flower 23, the butterfly, the bird, the fruit, and the Christmas tree can all be formed into a molded resin structure to exhibit a vivid colorful lighting variation. The degree of color and the line of silhouette is intensified by entirely or partially sand spraying the above molded transparent resin structure 38. Besides, the extra artifacts made of the mixture of the resin and stone powder accompanied with the plant further increase exquisiteness.

(Embodiment 2)

Referring to FIG. 4 in this embodiment, the plant trunk 8 and branch 9 of various flowers 23, leaf blades 24 fruits, birds and trees formed, the metallic tubular subamin 14 is formed of a plurality of flexible various sized capper bars. The slim electrical insulation conductor 2 pierces through the large aperture 118 opened at the upper portion of an internally threaded copper alloy connector 111 (see FIG. 30) and twists along the submain 14 to enter the pot. The diameter of the submain is enlarged by wrapping the electrical insulation conductors 2 with a cotton tape and the copper bar 21 for several layers, and then coating with colored resin painting or the mixture of resin painting and stone power mixture 39.

The slim electrical insulation conductors 2 connected to one terminal of LEDS 5 are connected to the positive terminal of the power supply switch 11 provided at the base of the lower pot chamber 26 via three apertures 7 opened on the two flanges; while the other negative terminal pins of the LEDS 5 are welded to the small aperture 118 opened on the copper alloy conductor 116 which being screw combined to the copper bars 21 forming the metallic tubular submain 14 so that the submain 14 serves as a negative conductor. The welding terminal plate provided on the copper bar at the trunk bottom is the other terminal of the submian 14, a conductor which being welded to it extends its other end and is welded to the base connector 22 in the lower pot chamer 26 so as to serve as a negative terminal thereby providing the means for the leaf blades 24, the flowers 23, the fruits and the birds to exhibit a variety of color change.

(Embodiment 3)

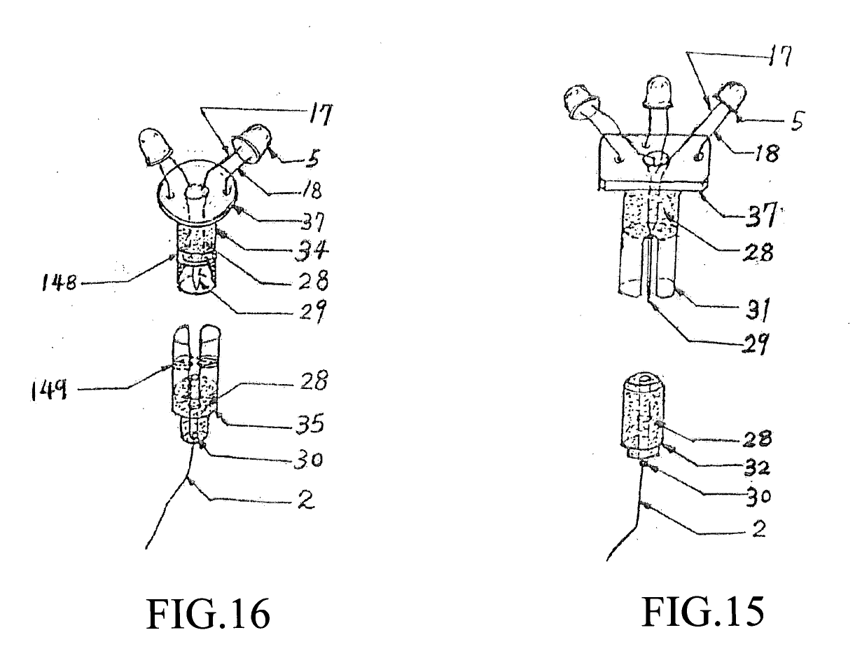

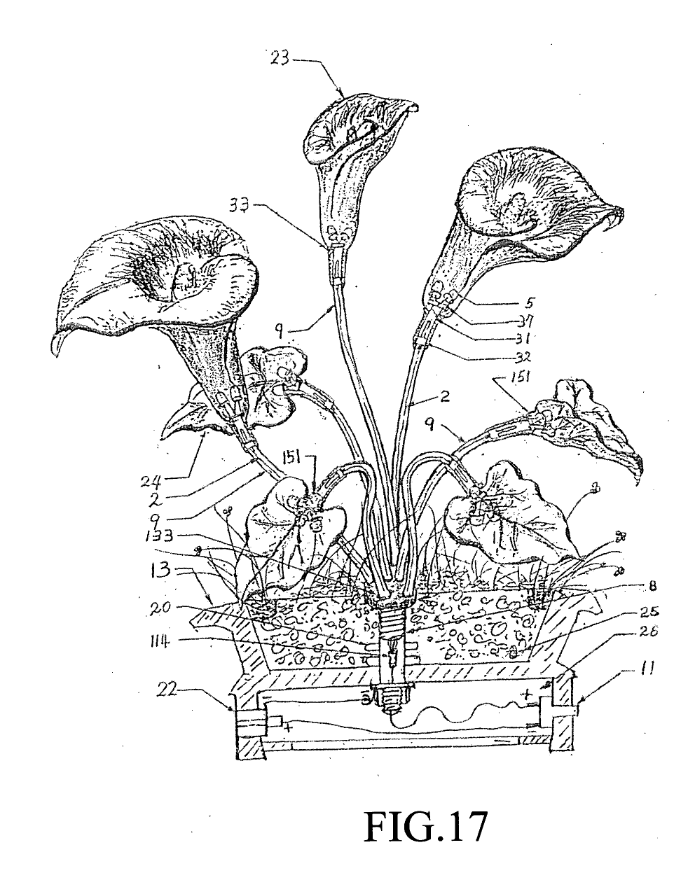

Referring to FIGS. 15,17,19 and 31, in this embodiment, the present invention comprises the LEDS 5, the metallic tubular submain 14, the electrical insulation conductors 2, a PCB 37, an insulation material 28, positive terminal pins 29, an inner tube 30, an A connector 31, a colored soft plastic bushing 33, an a receptacle, flowers 23, leaf blades 24 fruits, butterflies of molded transparent resin structure, and pots 13. The plant trunk 8 and branch 9 of metallic tubular submain 14 which being a bunch of a plurality of flexible and various sized metallic copper conductor tubes, copper alloy tubes, or metal plated (silver or tin) tubes 10 welded together. They can be flexed into a desired angle and coated with various colored resin painting, a color resin painting or a resin and stone power mixture 39 and then wrapped with a cotton tape 41 to increase its diameter.

Wherein the positive terminal pins 29 of the LEDS 5 which being connected in parallel are welded to the pin holes formed on a copper foil at the upper surface of the PCB 37; while the negative terminal pins of the LEDS 5 are welded to the negative side pin holes of the copper foil formed on the rear edge surface of the PCB 37. The positive terminal pins of the LEDS 5 and the positive terminal pins 29 are mutually connected, but the housing of the A connector 31 and the positive terminal pins 29 are

The A connector 31 is fitted into the A receptacle 32 so as to insert the positive terminal pin 29 into the inner tube 30. the lower end of the inner tube 30 is welded to the electrical insolation conductor 2 so as to form a positive tube conductor; while the bottom edge of the A receptacle 32 is welded or screw engaged to the metallic tubular submian 14 so as to provide a negative conductor. Then afterwards, the LEDS 5 are sealed in the molded transparent resin structure and the colored soft plastic bushing 33 is compressed onto the A connector 31 and A receptacle 32. In this version, the molded structure of the flowers and leaves can be efficiently replaced or changed their position if desired.

(Embodiment 4)

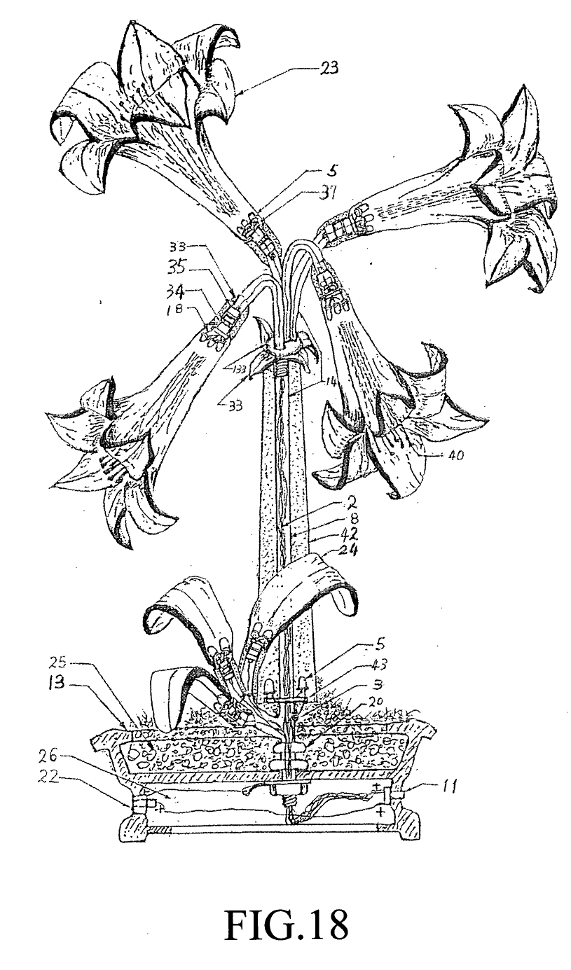

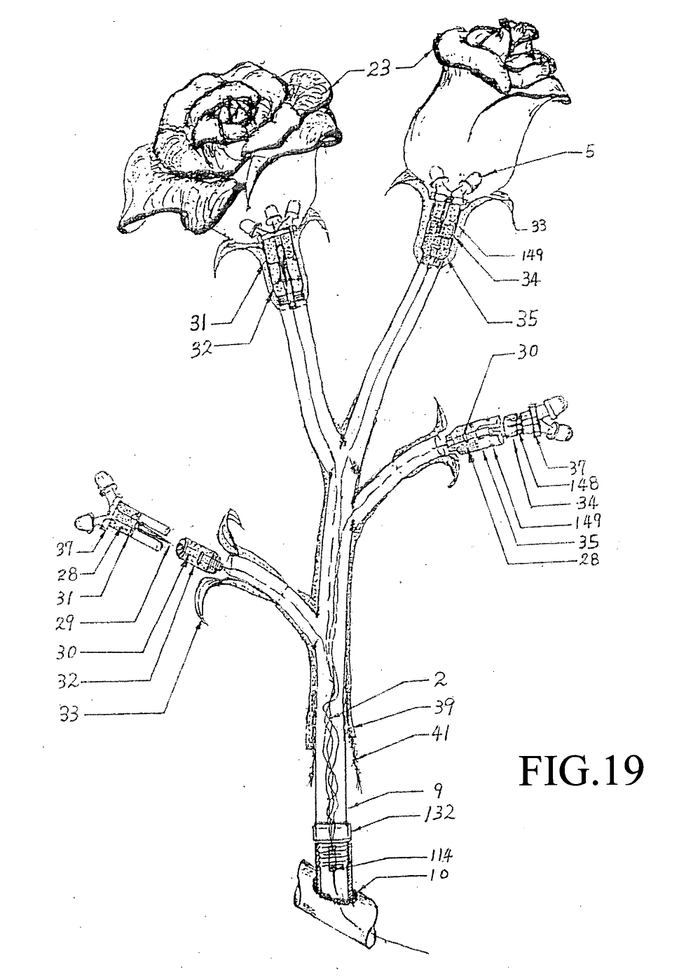

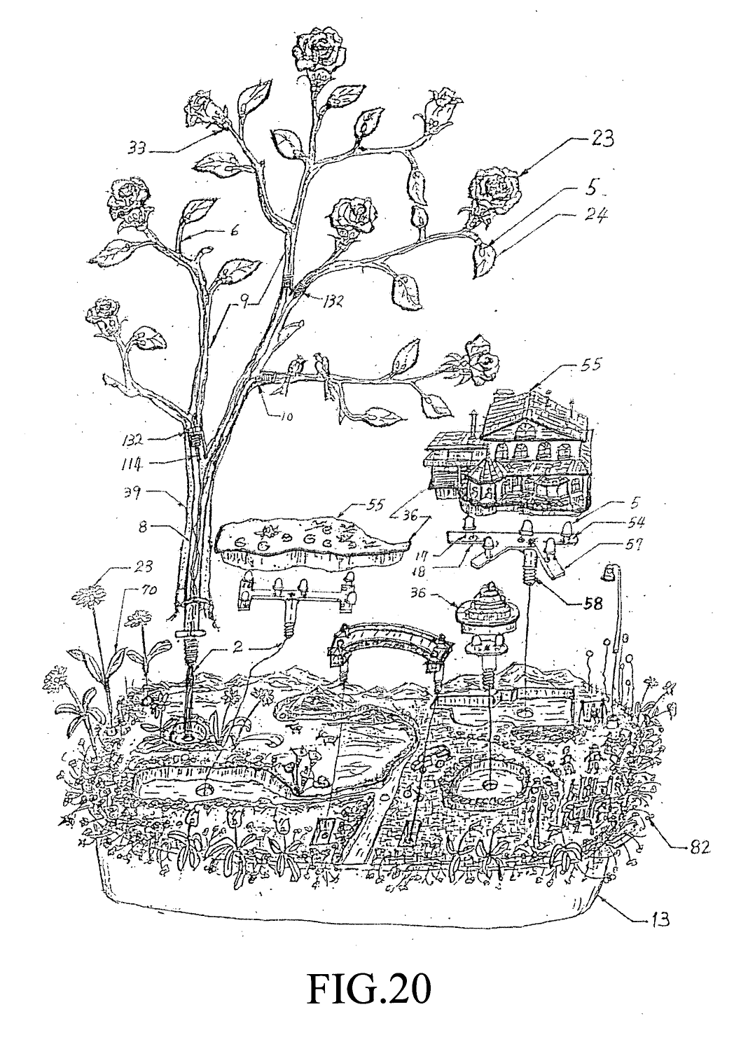

Referring to FIGS. 16,18 and 19, in this embodiment, the present invention comprises comprises a plurality of automatically color variable LEDS 5, flowers 23, leaf blades 24, birds, fruits, butterflies, metallic conductor branches 14, electrical insulation conductors 2, PCB 37, insulation material 28, positive terminal pins 29, inner tube 30, B connector 34, colored soft plastic bushing 33, B receptacle 35, and pots 13. The B connector 34 and a B receptacle 35 in which a groove 148 formed along the outer edge of the B connector 34 is inlaid into a flange 149 formed in the B receptacle 35. The trunk 8 and the branch 9 are both coated with the colored resin painting, or the trank 8 is covered by a molded structure formed of the mixture of the resin and the stone powder 42 (see FIG. 18). Here, the PCB 48 is welded to the bottom outer wall of the trunk 8 so as to weld the negative terminal pins of the LEDS 5 to the surface of the trunk 8 via a negative copper foil; while a positive copper foil provided at the outer edge of the PCB 43 is welded to a positive conductor together with the positive terminal pins of the LEDS 5 and inserted into a small aperture 3 formed on the bottom surface of the trunk 8. A pistil 40 (see FIG. 18) is connected to and stuck at the center portion of the molded flower structure near the head of the LEDS 5 with an optical fiber. The color light is directed by the optical fiber to its exposed round head.

Wherein the positive terminal pins 29 of the LEDS 5 which being connected in parallel are welded to the pin holes formed on a copper foil at the upper surface of the PCB 37; while the negative terminal pins of the LEDS 5 are welded to the negative side pin holes of the copper foil formed on the rear edge surface of the PCB 37. The positive terminal pins of the LEDS 5 and the positive terminal pins 29 are mutually connected, but the housing of the A connector 31 and the positive terminal pins 29 are isolated by the insulation material 28.

The B connector 34 is fitted into the B receptacle 35 so as to insert the positive terminal pin 29 into the inner tube 30. the lower end of the inner tube 30 is welded to the electrical insolation conductor 2 so as to form a positive tube conductor; while the bottom edge of the B receptacle 35 is welded or screw engaged to the metallic tubular submian 14 so as to provide a negative conductor. Then afterwards, the LEDS 5 are sealed in the molded transparent resin structure and the colored soft plastic bushing 33 is compressed onto the B connector 34 and B receptacle 35. In this version, the molded structure of the flowers and leaves can be efficiently replaced or changed their position if desired.

(Embodiment 5)

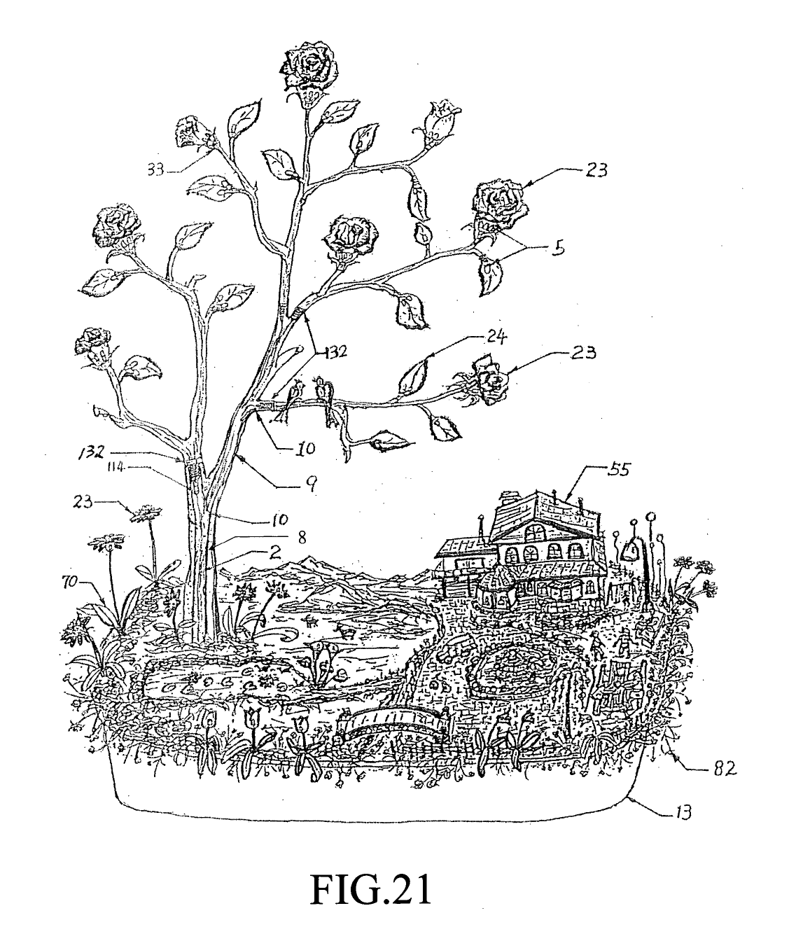

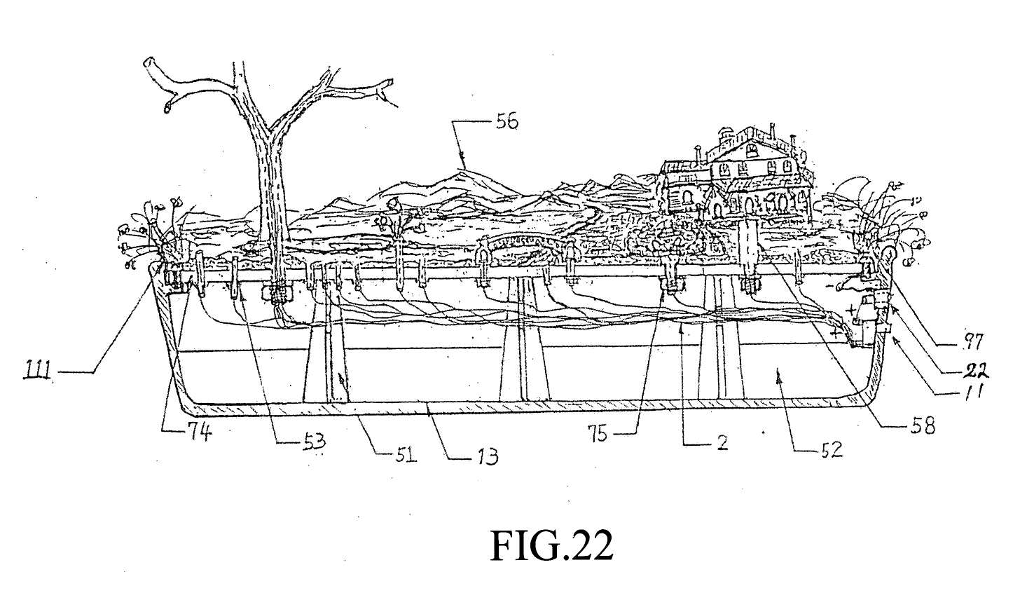

Referring to FIGS. 21 through 22, this embodiment is composed of a plurality of automatically color variable LEDS 5, flowers 23, leaf blades 24, birds, fruits, butterflies, metallic conductor branches 14, electrical insulation conductors 2, negative metallic base plate 74, A connector 31, A receptacle 32, B connector 34, B receptacle 35, artifact 55, miniature lands cape 56, and pots 13, the plant trunk 8 and branch 9 of various flowers 23, leaf blades 24 fruits, birds and trees formed, the embodiment 3 using the A connector 31 and the A receptacle 32 and the embodiment 4 using the B connector 34 and the B receptacle 35. A colored miniature landscape 56 is molded with mixture of resin, stone powder and fiber glass, the artifact 55 thereon is made of a molded transparent resin structure with LEDS 5. The clearance between the flange 36 around the artifact 55 and an indentation around the upper edge thereof is filled with a soft resin and is color painted. For decoration of the miniature lands cape 56, instead of a sponge groove 111, a bunch of slim vines are inserted on a spong 97 so as to serve as a suspention mustache ornament 82 (see FIG. 21).

Wherein the positive terminal pins 17 of the LEDS 5 which being connected in parallel are welded to the pin holes formed on a copper foil 54 at the upper surface of the PCB 57; while the negative terminal pins 18 of the LEDS 5 are welded to the negative side pin holes of the copper foil formed on the rear edge surface of the PCB 57.

A copper tube 58 is welded to the negative copper foil of the PCB 57 to serve as a negative conductor. The terminal pin of the copper tube 58 penetrates the miniature landscape 56 and fixed to a negative metallic base plate 74 with a nut and washer combination 75; while the negative metallic base plate 74 is sustained on the pot by stands 51 and a barrier plate 52 (see FIG. 22).

(Embodiment 6)

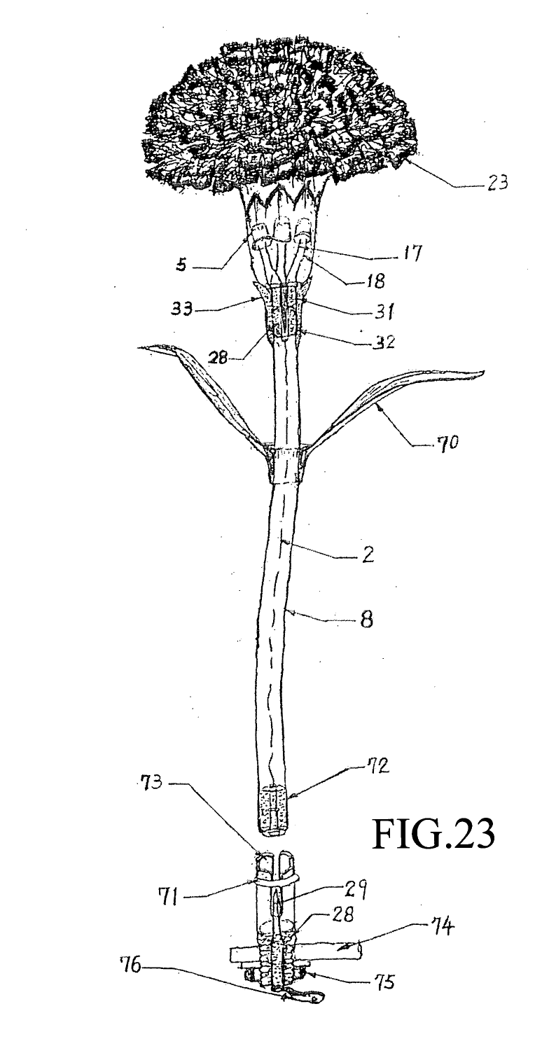

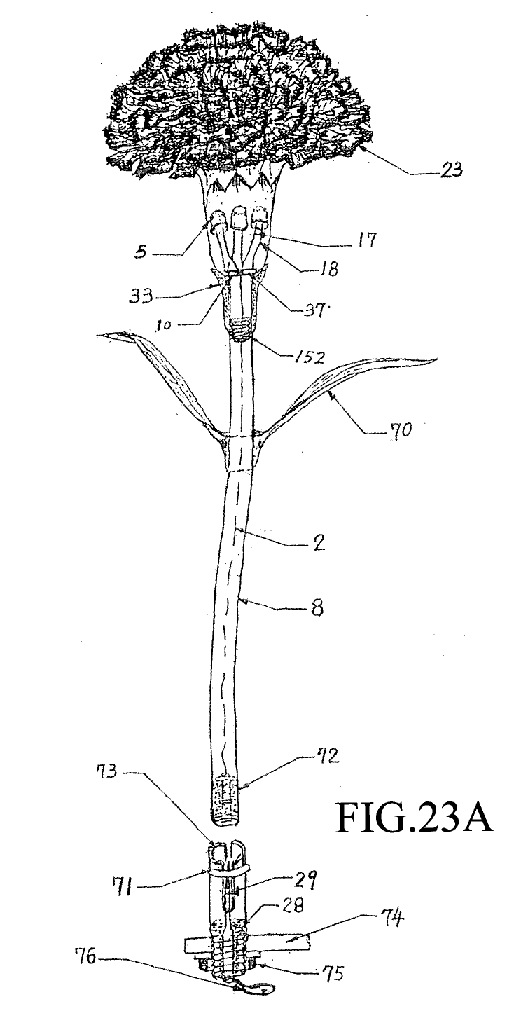

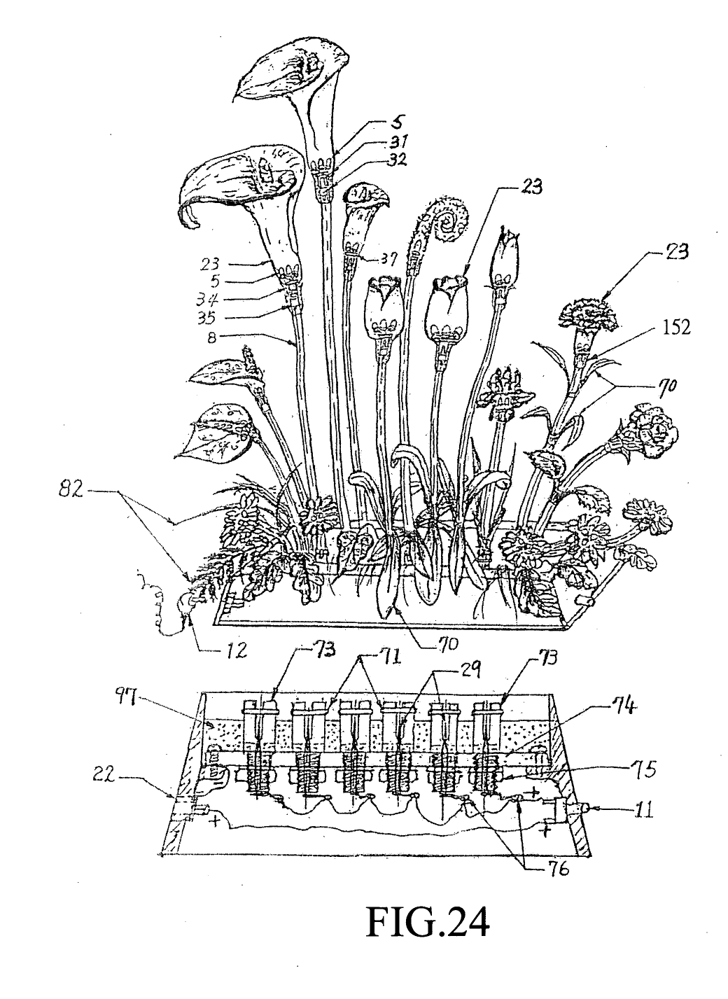

Referring to FIGS. 23 and 24, in this embodiment, this embodiment is composed of a plurality of automatically color variable LEDS 5, decorative foliage 70, A connector 31, A receptacle 32, B connector 34, B receptacle 35, coil spring 71, receptacle 72, negative copper alloy tube 73, negative metallic base plate 74, washer combination 76, the LEDS 5 is a combination of the embodiment 3 and 4. The positive and negative terminal pins of the LEDS 5 enclosed in the molded structure are respectively welded to the positive and negative PCB 37 copper foil formed an a C connector 152, and then C1 connector 152 is screw engaged, (or may use an externally threaded connector 121) to the upper portion of the trunk 8 (see FIG. 23A). The trunk 8 which sustains the flower 23 or other equivalents may fit its root which sustains the flower 23 or other equivalents may fit its root into a receptacle 72 whose inner hole is jointed to the positive terminal pins 29 of the negative copper alloy tube 73. A welding terminal plate belonging to the positive terminal pins 29 is connected to the power supply switch 11.

The trunk 8 entrains a decorative foliage 70 on its top, and its root is inserted into the negative copper alloy tube 73 which is fixed with nut and washer combination 76 to a hole formed on the negative metallic base plate 72, and the root of the trunk 8 and the negative copper alloy tube 73 are firmly pressed together with a coil spring 71. With this arrangement, the trunk 8 entraining various flowers and foliage can be sustained on the pot.

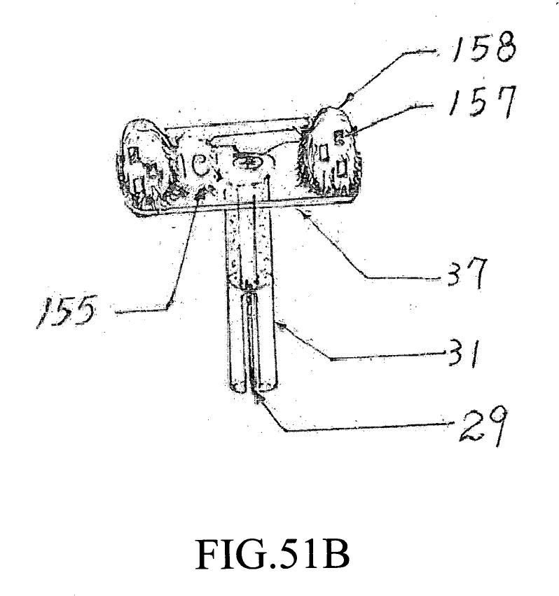

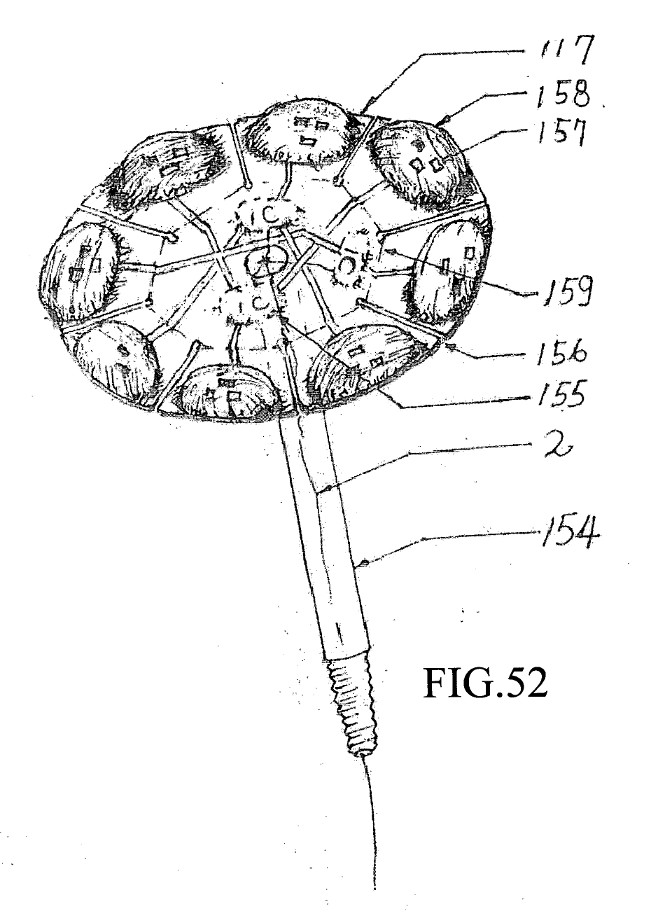

Referring to FIGS. 51 through 52, in order to shorten the time required for welding the colored LEDs 5 on the PCB 37 or the FPC 117 and facilitate sealing then in the molded transparent resin structure, the most of the confusing terminal pins of the most of the LEDs 5 are not used, instead of them, a plurality of R.G.B original color light emission dies 157 and their control IC 155 are implanted by silver solering directly on the PCB 37 or the FPC 117 using an automatic implanter, then afterwards, both the light emission dies 157 and the control IC 155 are covered with a epoxy resin cover 158 formed into a semi-spherical light focusing structure or a convexed rectangular light diffusing structure. The negative copper foil formed on the rear surface of the PCB 37 or the FPC 117 is welded to the upper terminal of an internally or externally thread tubular connector, an A type connector 31, or a B submain tube end.

(Embodiment 7)

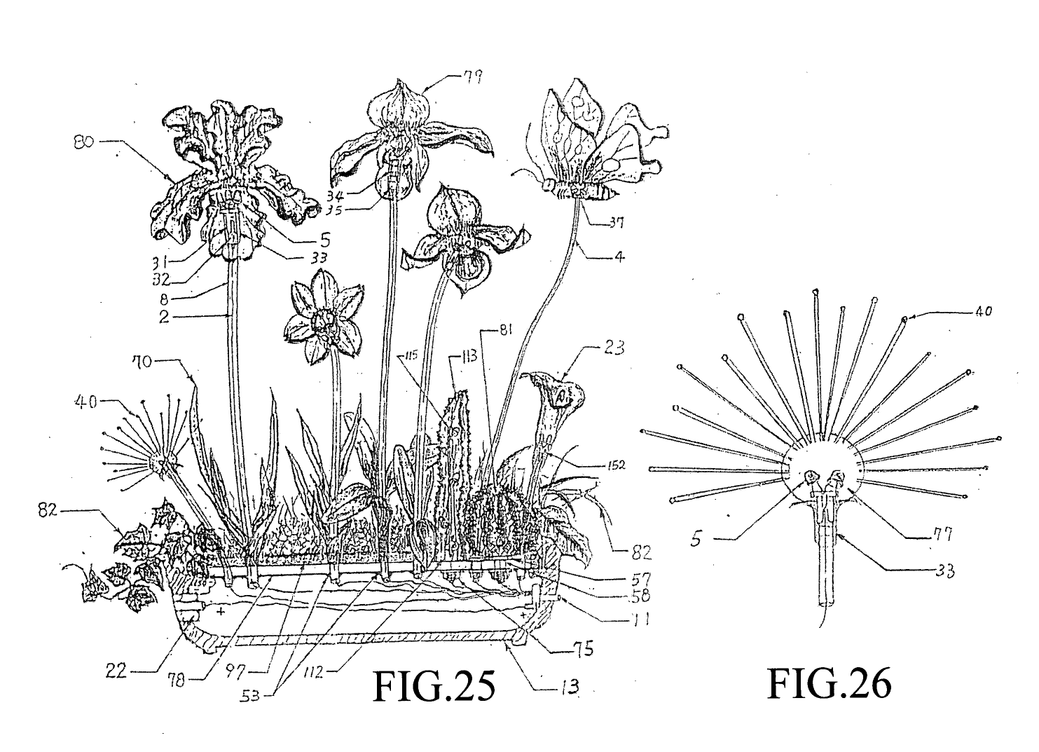

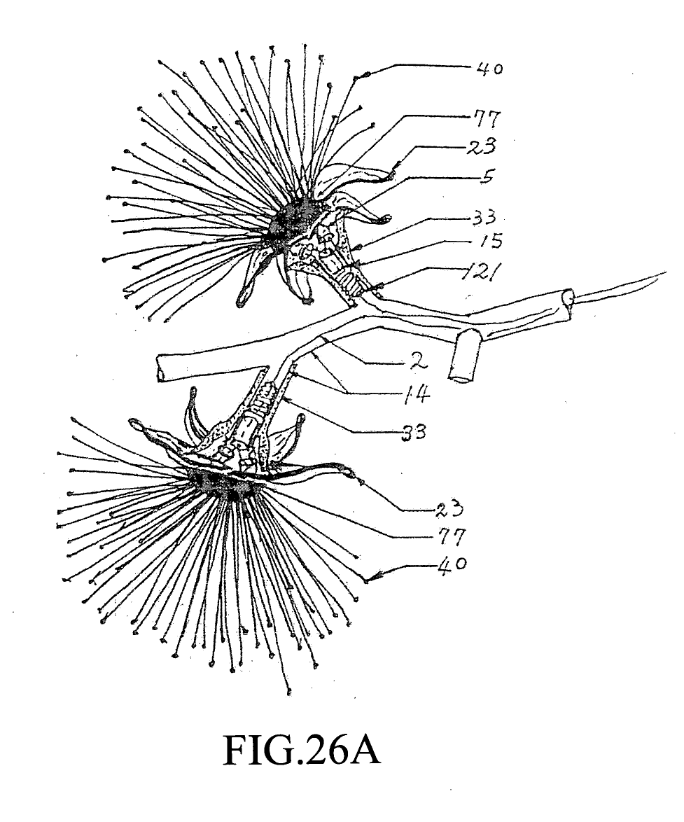

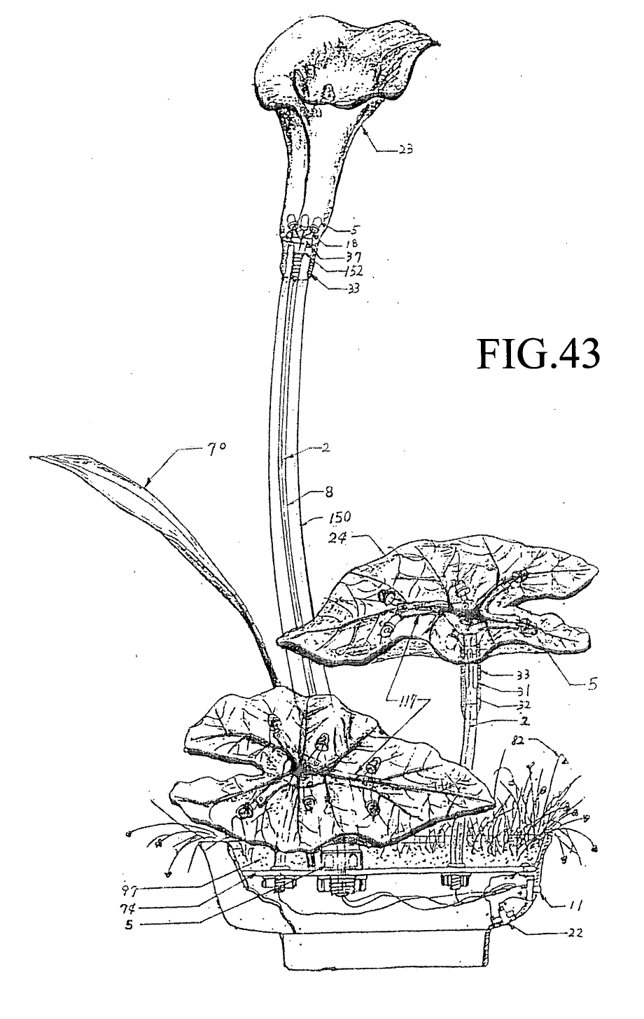

Referring to FIGS. 25 and 26, this embodiment is a combination of the former the embodiment 3 using the A connector 31 and the A receptacle 32 and the embodiment 4 using the B connector 34 and the B receptacle 35, the C1 connector 152 is screw engaged, (or may use an externally threaded connector 121) to the upper portion of the trunk. A dwarf cactus 81 may be disposed according to the way described above. For disposing a tall cactus 113 and artifact 38 (see FIGS. 25,13), an elongated strip shaped hard or soft circuit board 115 is installed in the moded transparent resin structure, the negative copper foil of the circuit board 115 is welded to a copper alloy clamp 112 which is clamped to a base plate 78 with a screw nut. For those medium sized flower 23, leaf blade 24 etc. a flexible irregular circuit board 117 is sealed in the molded structure (see FIGS. 43,47) and fitted to the receptacles 32,35 or screw engaged to the submain tube end. The LEDS 5 for illuminating the butterfly 16, the dragonfly or the flying bird, they may be fixed to the base plate 78 of the medium or small sized PCB using G1, G3, G4 slim alloy copper tubes 4 and their plugs 132. Besides, the root of the trunk 8 entraining the flower 23 such as an Alice orchid 80 or a cottlea SP. 79 is inserted into and welded to the through hole of the base plate 78. Hair like artificial conferous pine leaves or spadix flowers may be formed of the optical fibers 40 whose one end is bound to the molded transparent resin structure 77 as shown in FIGS. 26 and 26A, the molded transparent resin structure 77 comprises a plurality of automatically color variable LEDS 5, the plant trunk of A connector 31, the A receptacle 32 and the B connector 34, the B receptacle 35 formed, the color light is directed by the optical fiber to its exposed round head.

(Embodiment 8)

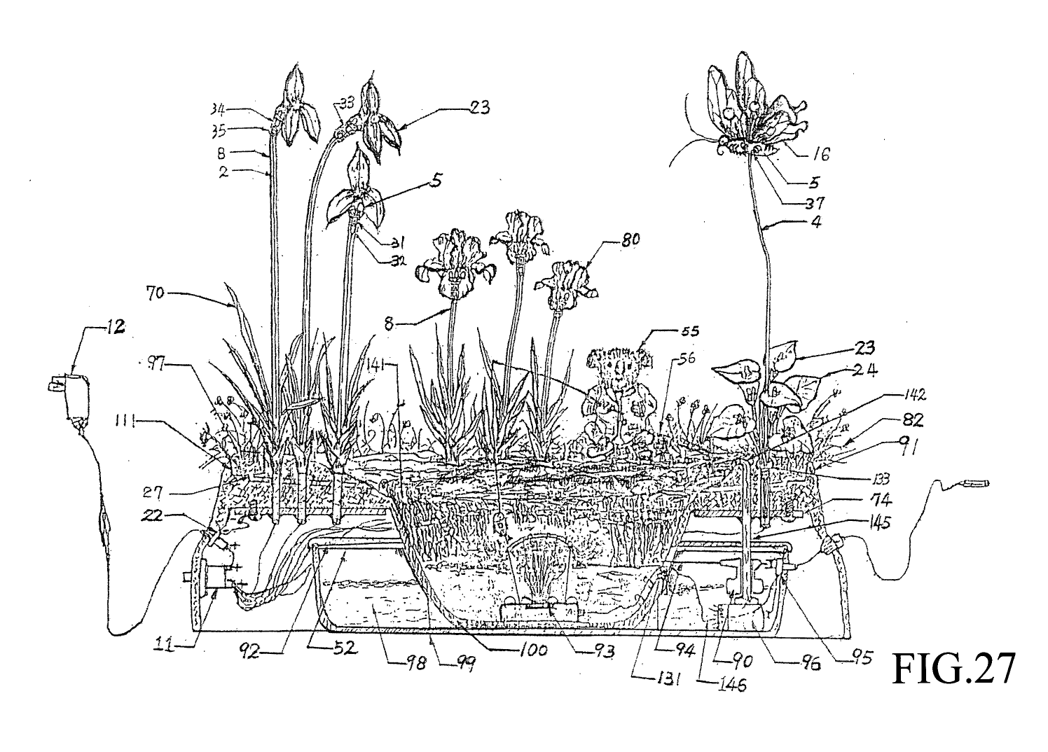

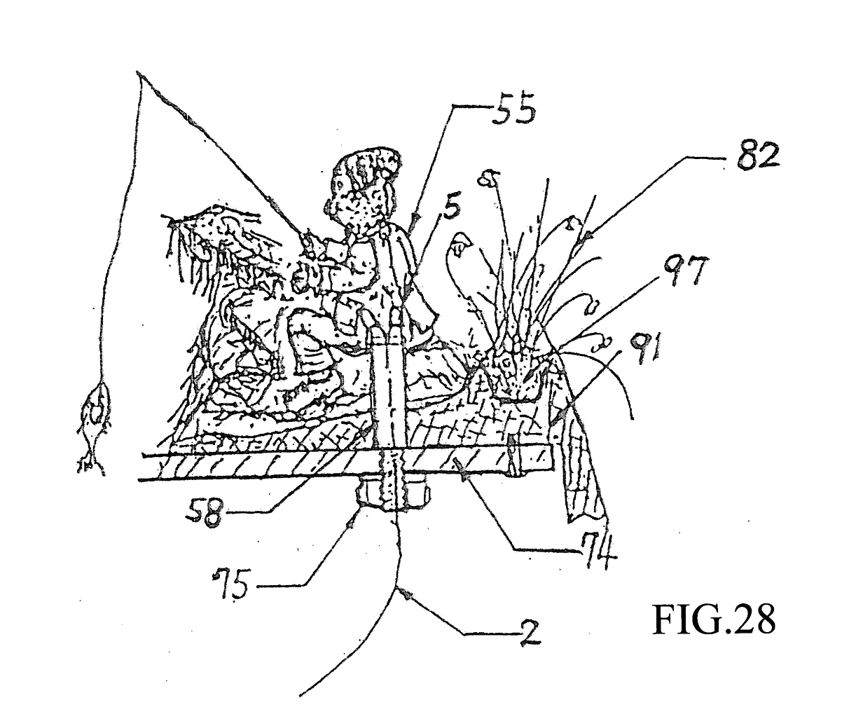

Referring to FIGS. 27 and 28, the present invention comprises the metallic tubular submian 14, molded transparent resin structure 23,24,55, a butterfly 16, a electrical insulation conductors 2, a bonsai pot 91, a lid 92, a fog generator 93, a water level detector 94, a microswitch 95, a submergible pump 96, a sponge groove, A connector 31, A receptacle 32, B connector 34, B receptacle 35, base connectors 22, the C1 connector 152 is screw engaged, (or may use an externally threaded connector 121) to the upper portion of the trunk, the colored soft plastic bushing 33 is compressed onto the embodiment 3 using the A connector 31 and the A receptacle 32 and the embodiment 4 using the B connector 34 and the B receptacle 35, the trunk 8 entrains a decorative foliage 70 on its top, the metallic tubular submian 14 fixed to a negative metallic base plate 74 with a nut and washer combination 75, the negative metallic base plate 74 is fixed into said a bonsai pot 91 with a binder made of mixed resin and ballasts, this embodiment comprises a bonsai pot 91 molded of a mixture of resin with stone powder and fiber glass, a water basin 99 placed beneath the bonsai pot 91, the weight of water basin 99 is sustained with its barrier plate 52 which also capable of positioning the water basin not to move. The water basin 99 also has a lid 92. the bonsai pot 91 includes a colored miniature landscape model 56, a pond 100, and an artifact 55. The pond 100 contains a fog generator 93, refined oil and water 98 in it. The water basin 99 contains a water level detector 94, a submergible pump 96, water, a float 90, and a microswitch 95. If the water level of the pond 100 is too high, the excessive water over flows out of an overflow port 131 and returns to the water basin 99. The display of a scenery of water screen and recycling water flow on the bonsai pot 91 is served by actuating the fog generator 93 and the pump 96 with the control of the micorswitch 95. When the water level of the pond 100 is too low, the microswitch 95 will trip to interrupt the power supply in accordance with the descending of the float 90 caused by the lowering of the water and refined oil 98 level.

A bunch of slim vines are inserted on a spong 97 of sponge groove 111 so as to serve as a suspention mustache ornament 82, the metallic tubular submain 14 are fixed on the lower chamber 26 to one positive terminal of the power supply switch 11, the negative terminal thereof is connected to the positive terminal of the base connector 22.

(Embodiment 9)

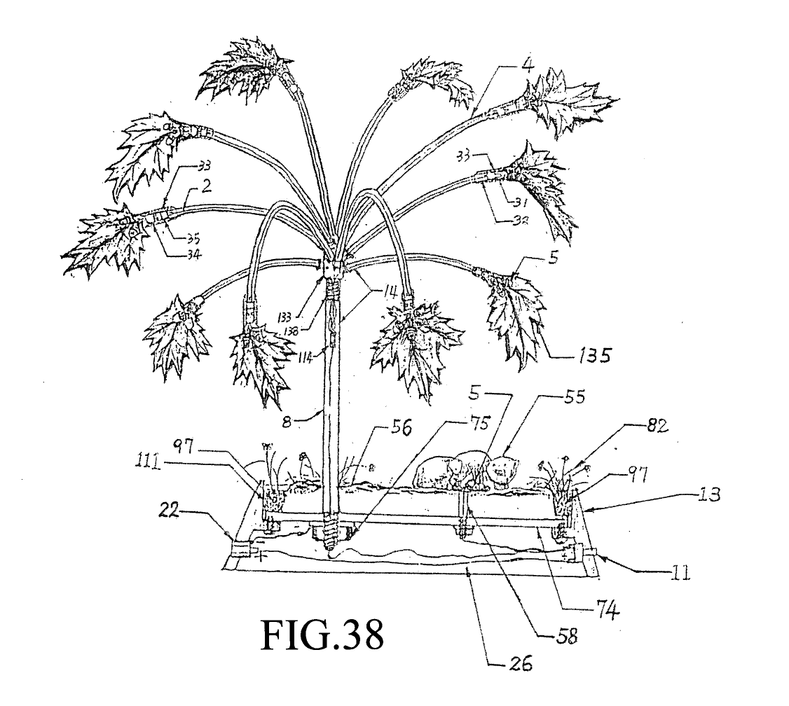

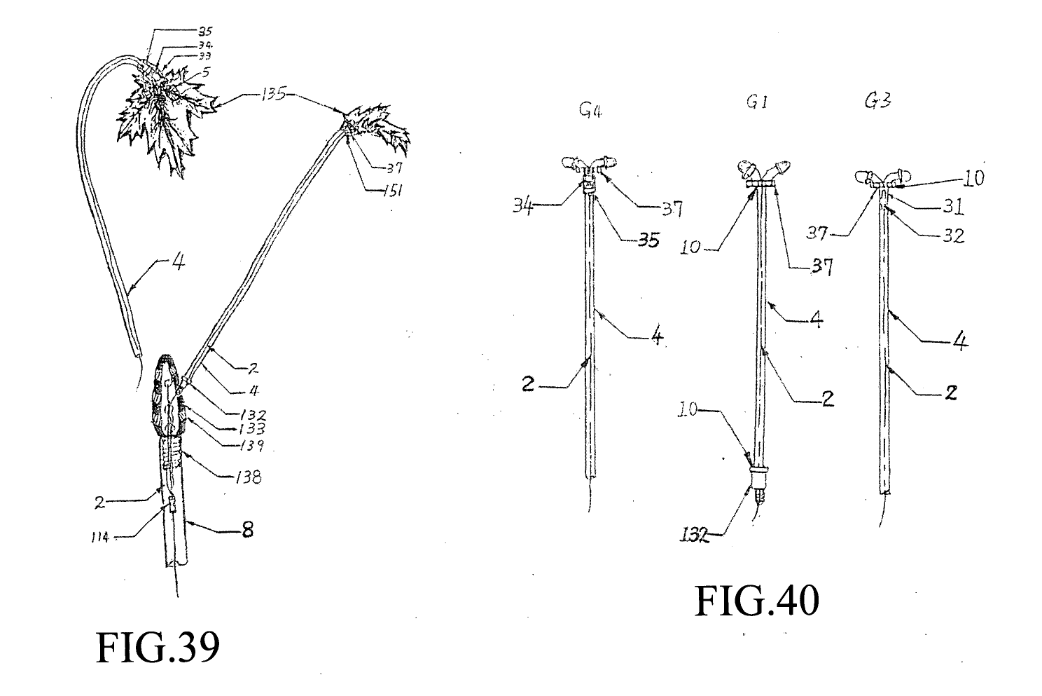

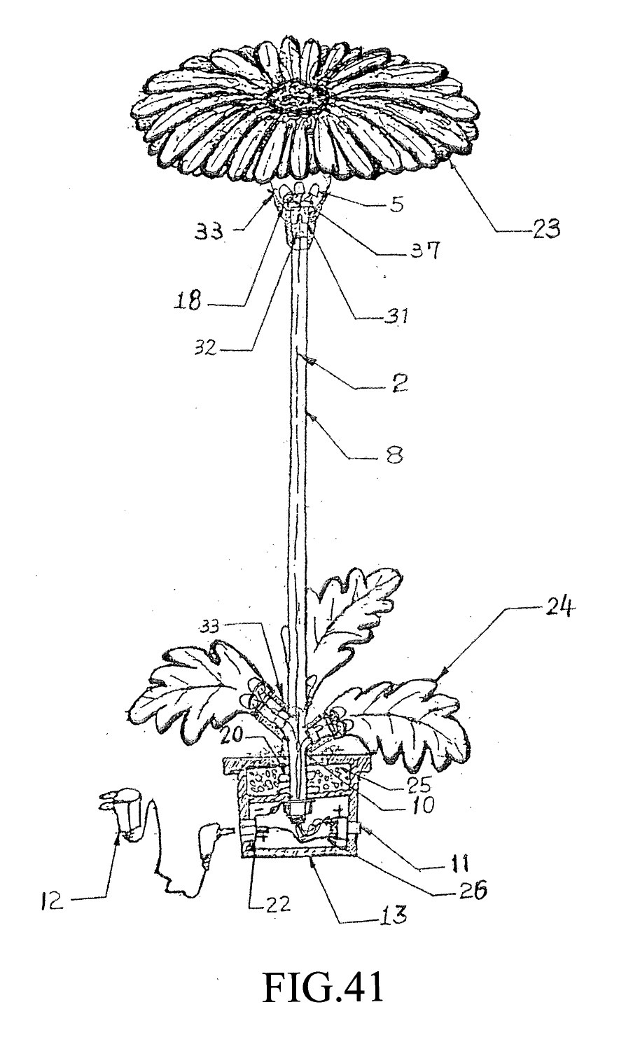

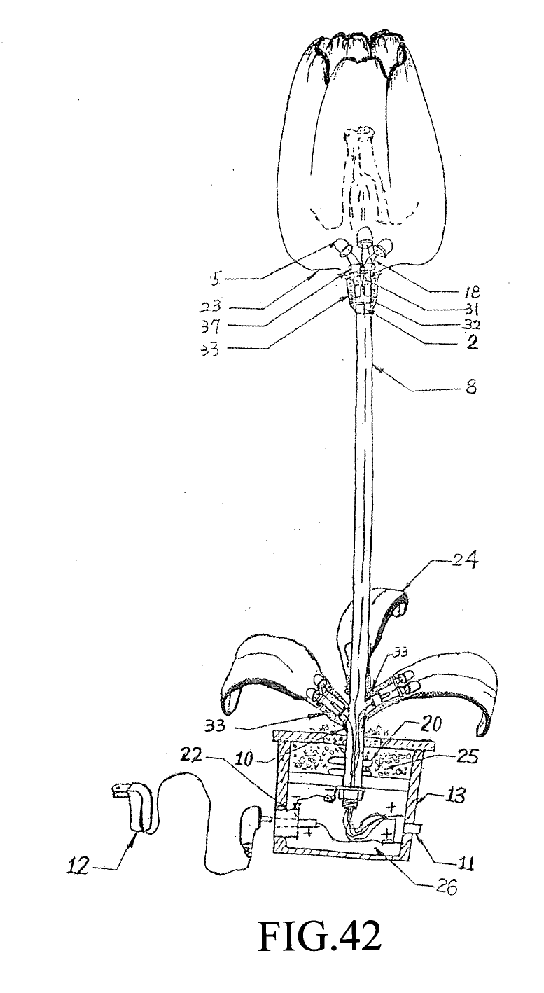

Referring to FIG. 38, the present invention comprises the metallic tubular submian 14, molded transparent resin structure 23,24,55, a electrical insulation conductors 2, A connector 31, A receptacle 32, B connector 34, B receptacle 35, base connectors 22, miniature landscape model 56, negative metallic base plate 74, sponge groove 111, copper alloy joints 132, main tube connector 133, the metallic tubular submain 14 which being a bunch of a plurality of flexible and various sized metallic copper conductor tubes, copper alloy tubes, or metal plated (silver or tin) tubes welded together, in this embodiment the tip of the trunk 8 is jointed with a main tube connector 133 by welding or screw engaging 138. Several screw passing holes 139 provided on the top of the main tube connector 133 are welded to, or screw engaged with several copper alloy tubes 4 which being covered with the molded transparent resin structure of the flower leaf, flying bird, or dragonfly (see FIG. 39), a cone shaped or a funnel shaped molded transparent resin structure 151 may be formed beneath the rear of the leaf blade so as to accommodated the LEDS 5 and a PCB, a PCB 37 using the A connector 31 and the A receptacle 32 and the embodiment 4 using the B connector 34 and the B receptacle 35. the LEDS 5 which being connected in parallel are formed on a copper foil at the upper/lower surface of the PCB 37, and one end of the copper alloy tube 4 is welded to the center portion of the negative copper foil provided beneath the PCB (see FIG. 40G1). The artifact 55 such as an artificial molded transparent resin structure of a raccoon idol is inlaid in the miniature landscape model 56 (see FIG. 38), For decoration of the miniature lands cape 56 and pots 13, instead of a sponge groove 111, a bunch of slim vines are inserted on a spong 97 so as to serve as a suspention mustache ornament 82.

The metallic tubular submain 14 are fixed on the lower chamber 26 to one positive terminal of the power supply switch 11, the negative terminal thereof is connected to the positive terminal of the base connector 22.

Many changes and modification in the above described embodiments of the invention can, of course, be carried out with out departing from the scope thereof. Accordingly, to promote the progress in science and the useful arts, the invention is disclosed and is intended to be limited only by the scope of the appended claims.

1. An artificial miniature landscape model with three dimensionally colored LEDS is essentially composed of a plurality of automatic color variable LEDS, metallic conductor submains, heat shrink bushings or heat resisting insulation tube plugs, externally or internally threaded tube connectors, electrical insulation conductors, a low voltage rectifier, flowers, leaf blades, fruits, birds, butterflies, coniferous Christmas trees formed into molded transparent resin structures, and pots.
Wherein it is characterized in that said LEDS are sealed in said molded transparent resin structure with a certain properly inclined angle, said submains of the potted plant are constructed of a plurality of various sized (diameters) copper tubes bent and welded, and being assembled section by section with screw engaging;
The root of a trunk of said potted plant is provided with two flanges and is fixed into said pot with a binder made of mixed resin and ballasts, the electricity is supply from a low voltage rectifier via a power supply switch to said leds.

2. The landscape model of claim 1, wherein a plurality of LEDS are sealed in a molded transparent resin structure formed between a leaf stalk and a leaf blade, a cone or a funnel shaped molded transparent resin structure is formed at the bottom of the leaf stalk and provided with an aperture in correspondence with a U or V aperture along the leaf blade of a real plant.

3. The landscape model of claim 1, wherein a plurality of R.G.B original color light emission dies and their control IC are implanted by silver solering directly on the PCB or the FPC using an automatic implanter, then afterwards, both the light emission dies and the control IC are covered with a epoxy resin cover formed into a semi-spherical light focusing structure or a convexed rectangular light diffusing structure, the negative copper foil formed on the rear surface of the PCB or the FPC is welded to the upper terminal of an internally or externally thread tubular connector, an A type connector, or a B type connector, alternatively it can be bolted to or fitted into the submain tube end.

4. The landscape model of claim 1, wherein the molded transparent resin structure can be entirely or partially sand sprayed to form a foggy surface, or partially color painted, or partially semi-transparently color sprayed so as to create an effect of layering color variation. Incidentally, the artificial butterfly feelers may employ optical fibers affixed to its head.

5. The landscape model of claim 1, wherein said metallic tubular submain which being a bunch of a plurality of flexible and various sized metallic copper conductor tubes, copper alloy tubes, or metal plated (silver or tin) tubes welded together, the positive terminal pins of the LED which being parallelly welded with a slim electrical insulation conductor is inserted into a heat shrink insulation bushing.

6. The landscape model of claim 1, wherein said the metallic tubular subamin is formed of a plurality of flexible various sized capper bars, the slim electrical insulation conductor pierces through the large aperture opened at the upper portion of an internally threaded copper alloy connector and twists along the submain to enter the pot. the diameter of the submain is enlarged by wrapping the electrical insulation conductors with a cotton tape and the copper bar for several layers, and then coating with colored resin painting or the mixture of resin painting and stone power.

7. The landscape model of claim 1, wherein said pot is divided into an upper and a lower chambers, two flanges formed with said upper chamber is fixed with a binder made of a mixture of resin and ballasts, said lower chamber is for accommodating said power supply switch and a base connector, said low voltage rectifier is accommodated in said lower chamber or placed externally.

8. The landscape model of claim 1, Wherein the positive terminal pins of the LEDS which being connected in parallel are welded on a copper foil at the upper surface of the PCB; while the negative terminal pins of the LEDS are welded to the negative side the copper foil formed on the rear edge surface of the PCB, the connector is fitted into the receptacle so as to insert the positive terminal pin into the inner tube, the lower end of the inner tube is welded to the electrical insolation conductor so as to form a positive tube conductor, while the bottom edge of the A receptacle 32 is welded or screw engaged to the metallic tubular submian so as to provide a negative conductor.

9. The landscape model of claim 8, wherein the electrical connection is performed employing plug connector and receptacle mating including A and B types, wherein said A connector is mated to said A receptacle; while said B connector is engaging its outer edge groove with said B receptacle's inner flange.

10. The landscape model of claim 8, wherein said molded resin structure of said trunk is made of a mixture of colored resin and a stone powder, or a foggy semi-transparent resin, a PCB for said LEDS is sealed in the bottom portion thereof and is welded to the wall of said trunk root.

11. The landscape model of claim 8, wherein said pistil is connected to and stuck at the center portion of the molded flower structure near the head of the LEDS with an optical fiber, the color light is directed by the optical fiber to its exposed round head.

12. The landscape model of claim 1, wherein said the root of a trunk of potted plant its root into a receptacle whose inner hole is jointed to the positive terminal pins of the negative copper alloy tube, a welding terminal plate belonging to the positive terminal pins is connected to the power supply switch, the trunk entrains a decorative foliage on its top, and its root is inserted into the negative copper alloy tube which is fixed with nut and washer combination to a hole formed on the negative metallic base plate, and the root of the trunk and the negative copper alloy tube are firmly pressed together with a coil spring, with this arrangement, the trunk entraining various flowers and foliage can be sustained on the pot.

13. The landscape model of claim 12, wherein said the trunk is inserted into and welded to the through hole of the base plate, or screw to the formed on a copper foil at the upper surface of the PCB, the electrical insulation conductors to one positive terminal of the power supply switch, the negative terminal thereof is connected to the positive terminal of the base connector.

14. The landscape model of claim 12, wherein said an elongated strip shaped hard or soft circuit board is installed in the moded transparent resin structure, the negative copper foil of the circuit board is welded to a copper alloy clamp which is clamped to a base plate with a screw nut. For those medium sized flower, leaf blade etc. a flexible irregular circuit board is sealed in the molded structure and fitted to the receptacles or screw engaged to the submain tube end.

15. The landscape model of claim 12, wherein said hair like artificial conferous pine leaves or spadix flowers may be formed of the optical fibers whose one end is bound to the molded transparent resin structure, a pistil is connected to and stuck at the center portion of the molded flower structure near the head of the LEDS with an optical fiber, the color light is directed by the optical fiber to its exposed round head.

16. The landscape model of claim 1, wherein said this embodiment comprises a bonsai pot, a water basin placed beneath the bonsai pot, the weight of water basin is sustained with its barrier plate which also capable of positioning the water basin not to move. the water basin also has a lid, the metallic tubular submain are fixed on the lower chamber to one positive terminal of the power supply switch, the negative terminal thereof is connected to the positive terminal of the base connector

17. The landscape model of claim 16, wherein said bonsai pot molded of a mixture of resin with stone powder and fiber glass, a spong and sponge groove on on the bonsai pot, a hole on sponge groove.

18. The landscape model of claim 16, wherein said the pond contains a fog generator, refined oil and water in it.

19. The landscape model of claim 16, wherein said the water basin contains a water level detector, a submergible pump, water, a float, and a microswitch.

20. The landscape model of claim 1, wherein the positive and negative terminal pins of said LEDs enclosed in said molded resin structure are welded to the copper foil underneath said PCB, the end of said slim copper alloy tube is welded underneath the center portion of the copper foil of said PCB, while the other end thereof is fitted into a threaded copper alloy connector and being welded thereat, several slim copper alloy tube is fixed to a tapped hole of a main tubular connector which being configurated into an olive shape, a sphere, or a polyhedron, the tip of said trunk and the bottom of said main tubular connector is jointed by welding or screw engaging, the threaded root of said trunk is fitted into a negative metallic base plate and fixed by nut and washer combination, a sponge groove is formed between the inner edge of said pot and the outer edge of an artifact, each slim electric insulation conductor is welded to an insulation compressive terminal and then welded to one terminal of said power supply switch at said pot lower chamber via a main conducting tube, while the other terminal of said power supply switch is connected with the positive terminal of the base connector, said negative metallic base plate which is a negative conductor is connected with the negative terminal of said base connector.
